(19) United States
(12) Patent Application Publication
(10) Pub. No.: US 2023/0012094 A1
(43) Pub. Date: Jan. 12, 2023

(54) SYSTEMS AND METHODS FOR FLUID SENSING USING PASSIVE FLOW

(71) Applicant: SiPhox, Inc., Burlington, MA (US)

(72) Inventors: Michael Dubrovsky, Somerville, MA (US); Pengguan Yu, Burlington, MA (US); Diedrik Rene Vermeulen, Somerville, MA (US)

(73) Assignee: SiPhox, Inc., Burlington, MA (US)

(21) Appl. No.: 17/859,932

(22) Filed: Jul. 7, 2022

Related U.S. Application Data
(60) Provisional application No. 63/219,020, filed on Jul. 7, 2021.
(60) Provisional application No. 63/219,025, filed on Jul. 7, 2021.

(51) Int. Cl. G01N 11/04; G01F 1/661; B01L 3/00

(52) U.S. Cl. CPC G01N 11/04; G01F 1/661; B01L 3/502746; G01N 2011/008

(57) ABSTRACT

Aspects relate to systems and methods for fluid sensing using passive flow. An exemplary system includes a microfluidic device, the microfluidic device including at least a reservoir configured to contain at least a fluid and at least a passive flow component in fluidic communication with the at least a reservoir and configured to flow the at least a fluid with predetermined flow properties, at least an sensor device configured to be in sensed communication with the at least a fluid and detect at least a sensed property; and at least an sensor interface configured to wet at least a surface of the at least a sensor device with the at least a fluid.

### CROSS-REFERENCE TO RELATED APPLICATIONS

This Non-provisional application claims the benefit of priority from U.S. Provisional Patent Application Ser. No. 63/219,020, filed on Jul. 7, 2021, and titled “Passive Flow Microfluidic Cartridge with Timing Controlled Flow” and U.S. Provisional Patent Application Ser. No. 63/219,025, filed on Jul. 7, 2021, and titled “Passively Driven Microfluidic System with Sensor Interface,” both of which are incorporated by reference herein in their entirety.

### FIELD OF THE INVENTION

The present invention generally relates to the field of sensing. In particular, the present invention is directed to systems and methods for fluid sensing using passive flow.

### BACKGROUND

Sensing of biological materials often requires large quantities of blood samples for accurate readings. Drawing blood requires trained medical personnel.

### SUMMARY OF THE DISCLOSURE

In an aspect, an exemplary system for fluid sensing using passive flow includes a microfluidic device, the microfluidic device including at least a reservoir configured to contain at least a fluid and at least a passive flow component in fluidic communication with the at least a reservoir and configured to flow the at least a fluid with predetermined flow properties, at least an sensor device configured to be in sensed communication with the at least a fluid and detect at least a sensed property; and at least a sensor interface configured to wet at least a surface of the at least a sensor device with the at least a fluid.

In another aspect, an exemplary method for fluid sensing using passive flow includes containing, using at least a reservoir of a microfluidic device, at least a fluid, flowing, using at least a passive flow component in fluidic communication with the at least a reservoir, the at least a fluid with predetermined flow properties, wetting, using at least a sensor interface, at least a surface of at least a sensor device with the at least a fluid, and detect, using the at least a sensor device configured to be in sensed communication with the at least a fluid, as least a sensed property.

In another aspect, an exemplary system for fluid sensing using passive flow includes a microfluidic device, the microfluidic device including at least a reservoir configured to contain at least a fluid and at least a passive flow component in fluidic communication with the at least a reservoir and configured to flow the at least a fluid with predetermined flow properties, at least an optical device configured to be in sensed communication with the at least a fluid, wherein the at least an optical device includes at least a waveguide configured to propagate an electromagnetic radiation (EMR) and at least a sensor in optical communication with the at least a waveguide configured to detect a variance in at least an optical property associated with the at least a fluid, and at least an optical interface configured to wet the at least a waveguide with the at least a fluid.

In another aspect, an exemplary method for fluid sensing using passive flow includes containing, using at least a reservoir of a microfluidic device, at least a fluid, flowing, using at least a passive flow component in fluidic communication with the at least a reservoir, the at least a fluid with predetermined flow properties, propagating, using at least a waveguide of at least an optical device configured to be in sensed communication with the at least a fluid, an electromagnetic radiation (EMR), wetting, using at least an optical interface, the at least a waveguide with the at least a fluid, and detect, using at least a sensor in optical communication with the at least a waveguide, a variance in at least an optical property associated with the at least a fluid.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram illustrating an exemplary system for fluid sensing using passive flow, according to some embodiments;

FIG. 2 illustrates an exemplary microfluidic system with a sequential flow and channels connecting a variety of microfluidic components, according to some embodiments;

FIG. 3A shows the exemplary microfluidic system of FIG. 2, having a sample added and initiating flow, according to some embodiments;

FIG. 3B shows the exemplary microfluidic system of FIG. 2, having the sample sequentially flow into a reagent reservoir, according to some embodiments;

FIG. 3C shows the exemplary microfluidic system of FIG. 2, having the sample pass by a sensor interface and sensor device and flow to a passive flow device, according to some embodiments;

FIG. 3D shows the exemplary microfluidic system of FIG. 2, where a waste solution fills the waste reservoir to a level that triggers a channel, resulting in release of a reagent solution, according to some embodiments;

FIG. 3E shows the exemplary microfluidic system of FIG. 2, where the reagent passes a sensor and the reagent chamber becomes empty, concluding microfluidic analysis, according to some embodiments;

FIG. 4 illustrates a simplified embodiment of a microfluidic system, according to some embodiments;

FIG. 5 shows an example of a biological detection sequence and reaction at a surface of a sensor device, according to some embodiments;

FIG. 6 shows an exemplary response curve corresponding to different stages of flow in an exemplary microfluidic system, according to some embodiments;

FIG. 7 illustrates an exemplary reagent reservoir, according to some embodiments;

FIG. 8 shows an example of a sample injected into a sample reservoir, according to some embodiments;

FIG. 9 illustrates a top-down view of an exemplary sensor device is mounted to an exemplary microfluidic device, according to some embodiments;

FIG. 10 illustrates a cross-sectional view of an exemplary sensor device mounted to an exemplary microfluidic device, according to some embodiments;

FIGS. 11A-B, 12A-B, and 13 illustrate various non-limiting exemplary designs for a microfluidic device, according to some embodiments;

FIGS. 14-15 shows illustrative examples of possible packaging for an exemplary system for fluid sensing using passive flow, according to some embodiments;

FIG. 16 shows a top-down view of an exemplary disposable system for fluid sensing using passive flow, according to some embodiments;

FIG. 17 illustrates a side view of the exemplary disposable system of FIG. 16, according to some embodiments;

FIG. 18 shows an exemplary system for fluid sensing using passive flow having a lateral flow strip, according to some embodiments;

FIG. 19 shows an exemplary system for fluid sensing using passive flow having a lateral flow strip arrangement that allows sequencing of two or more assay steps, according to some embodiments;

FIG. 20 illustrates a top and cross-sectional view of an exemplary sensor interface, according to some embodiments;

FIG. 21 illustrates a top and cross-sectional view of an exemplary assembly in a first step of assembly, according to some embodiments;

FIG. 22 illustrates a top and cross-sectional view of an exemplary assembly in a second step of assembly, according to some embodiments;

FIG. 23 illustrates a top and cross-sectional view of an exemplary assembly in a third step of assembly, according to some embodiments;

FIG. 24 shows a first exemplary microfluidic device layout, according to some embodiments;

FIG. 25 shows a second exemplary microfluidic device layout, according to some embodiments;

FIG. 26 shows a third exemplary microfluidic device layout, according to some embodiments;

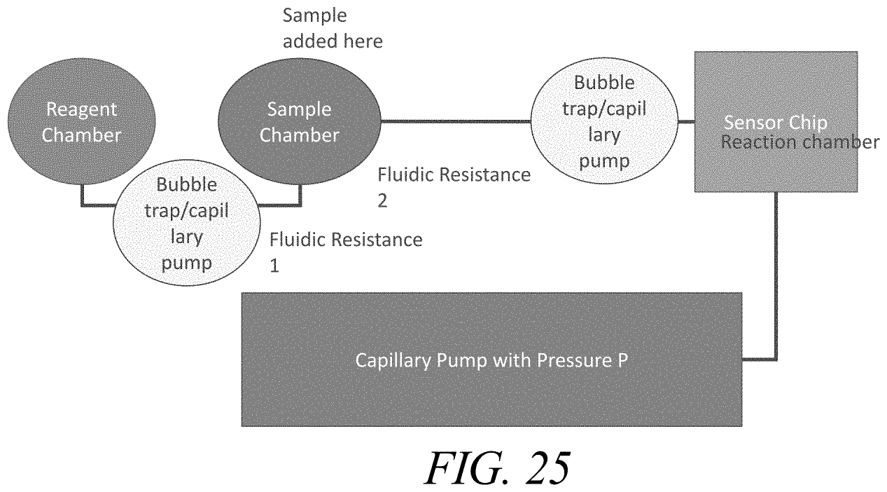

FIG. 25 shows a fourth exemplary microfluidic device layout, according to some embodiments;

FIG. 28 shows an exemplary system for fluid sensing using passive flow having exemplary locating features, according to some embodiments;

FIG. 29 is an image of an exemplary microfluidic device, according to some embodiments;

FIG. 30 shows a set of four time lapse images capturing an exemplary passive flow, according to some embodiments;

FIG. 31 illustrates an exemplary model inputs using a block diagram, according to some embodiments;

FIG. 32 is a graph showing exemplary stages of flow, according to some embodiments;

FIG. 33-41 are graphs showing exemplary performance of an exemplary microfluidic device, according to some embodiments;

FIG. 42 shows a first additional exemplary microfluidic assay, according to some embodiments;

FIG. 43 shows a second additional exemplary microfluidic assay, according to some embodiments;

FIG. 44 shows a third additional exemplary microfluidic assay, according to some embodiments;

FIG. 45 is a flow diagram of a method for fluid sensing using passive flow; and

FIG. 4646 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to systems and methods for fluid sensing using passive flow. In an embodiment, sensing is performed using a sensor device and fluid functions are performed using a microfluidic device.

Aspects of the present disclosure can be used to test fluid samples. Aspects of the present disclosure can also be used to test biological samples. Exemplary embodiments illustrating aspects of the present disclosure are described below in the context of several specific examples.

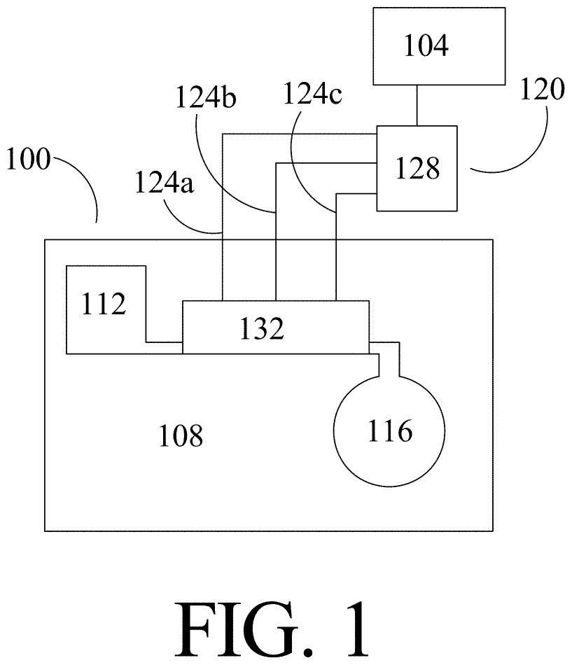

Referring now to FIG. 1, an exemplary embodiment of a system 100 for fluid sensing using passive flow is illustrated. As used in this disclosure, “passive flow” is flow of fluid, which is induced absent any external actuators, fields, or power sources. Passive flow techniques may include, without limitation osmosis, capillary action, surface tension, pressure, gravity-driven flow, hydrostatic flow, vacuums, and the like. System includes a computing device 104. Computing device 104 may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. Computing device 104 may include a single computing device operating independently, or may include two or more computing device operating in concert, in parallel, sequentially or the like; two or more computing devices may be included together in a single computing device or in two or more computing devices. Computing device 104 may interface or communicate with one or more additional devices as described below in further detail via a network interface device. Network interface device may be utilized for connecting computing device 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Computing device 104 may include but is not limited to, for example, a computing device or cluster of computing devices in a first location and a second computing device or cluster of computing devices in a second location. Computing device 104 may include one or more computing devices dedicated to data storage, security, distribution of traffic for load balancing, and the like. Computing device 104 may distribute one or more computing tasks as described below across a plurality of computing devices of computing device, which may operate in parallel, in series, redundantly, or in any other manner used for distribution of tasks or memory between computing devices. Computing device 104 may be implemented using a “shared nothing” architecture in which data is cached at the worker, in an embodiment, this may enable scalability of system 100 and/or computing device.

With continued reference to FIG. 1, computing device 104 may be designed and/or configured to perform any method, method step, or sequence of method steps in any embodiment described in this disclosure, in any order and with any degree of repetition. For instance, computing device 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, system 100 may include a microfluidic device 108. As used in this disclosure, a “microfluidic device” is a device that is configured to act upon fluids at a small scale (e.g., sub-millimeter). Commonly, at small scales, surface forces dominate volumetric forces. Microfluidic devices are explained in greater detail in this disclosure, below.

Still referring to FIG. 1, in some embodiments, microfluidic device 108 with integrated sensors 128 may be utilized in an advanced diagnostic device 100 for detection of biological signatures (e.g., viruses, bacteria, pathogens, and the like). In some cases, sensors 128 (e.g., biological, electrochemical, etc.) may be fabricated on a substrate, such as a silicon wafer or glass substrate. Substrate or wafer may then be diced into small chips. Chips may also be fabricated with a microfluidic circuit etch or patterned on them. Alternatively or additionally, they can be coupled to a microfluidic circuit fabricated separately on another substrate such as plastic or glass.

With continued reference to FIG. 1, microfluidic device 108 may include at least a reservoir 112. Reservoir 112 may be configured to contain at least a fluid. As used in this disclosure, a “reservoir” is a container for a fluid. A reservoir may include a channel, a well, or the like. A reservoir may have at least an inlet, at least an outlet, or both. A reservoir 112 may include, without limitation, a well, a channel, a flow path, a flow cell, a pump, and the like.

With continued reference to FIG. 1, microfluidic device 108 may include at least a passive flow component 116. As used in this disclosure, a “passive flow component” is a component, typically of a microfluidic device, that imparts a passive flow on a fluid. Exemplary non-limiting passive flow devices are explained in greater detail in this disclosure below. Passive flow component 116 may be in fluidic communication with at least a reservoir 112. Passive flow component 116 may be configured to flow at least a fluid with predetermined flow properties. As used in this disclosure, “flow properties” are characteristics related to a flow of a fluid. For instance, exemplary non-limiting flow properties include flow rate (in nl/min), flow velocity, integrated flow volume, pressure, differential pressure, and the like.

Still referring to FIG. 1, in some embodiments, microfluidic device 108 alternatively or additionally with passive flow component may include one or more pumps. Pump may include a substantially constant pressure pump (e.g., centrifugal pump) or a substantially constant flow pump (e.g., positive displacement pump, gear pump, and the like). Pump can be hydrostatic or hydrodynamic. As used in this disclosure, a “pump” is a mechanical source of power that converts mechanical power into fluidic energy. A pump may generate flow with enough power to overcome pressure induced by a load at a pump outlet. A pump may generate a vacuum at a pump inlet, thereby forcing fluid from a reservoir into the pump inlet to the pump and by mechanical action delivering this fluid to a pump outlet. Hydrostatic pumps are positive displacement pumps. Hydrodynamic pumps can be fixed displacement pumps, in which displacement may not be adjusted, or variable displacement pumps, in which the displacement may be adjusted. Exemplary non-limiting pumps include gear pumps, rotary vane pumps, screw pumps, bent axis pumps, inline axial piston pumps, radial piston pumps, and the like. Pump may be powered by any rotational mechanical work source, for example without limitation and electric motor or a power take off from an engine. Pump may be in fluidic communication with at least a reservoir. In some cases, reservoir may be unpressurized and/or vented. Alternatively, reservoir may be pressurized and/or sealed.

With continued reference to FIG. 1, system 100 may include at least a sensor device 120. Sensor device 120 may be configured to be in sensed communication with at least a fluid contained within or otherwise acted upon by microfluidic device 108. As used in this disclosure, a “sensor device” is any device including at least a sensor that detects property as a function of a phenomenon. In some embodiments, a sensor device may include an optical device. As used in this disclosure, an “optical device” is any device that generates, transmits, detects, or otherwise functions using electromagnetic radiation, including without limitation ultra-violet light, visible light, near infrared light, infrared light, and the like.

With continued reference to FIG. 1, optical device 120 may include at least a waveguide 124a-c. At least a waveguide may include a plurality of waveguides, for example a first waveguide 124a, a second waveguide 124b, a third waveguide 124c, and the like. As used in this disclosure, a “waveguide” is a component that is configured to propagate electromagnetic radiation, including without limitation ultra-violet light, visible light, near infrared light, infrared light, and the like. A waveguide may include a lightguide, a fiberoptic, or the like. A waveguide may include a grating within a transmissive material. In some cases, a waveguide may be configured to function as one or more optical devices, for example a resonator (e.g., microring resonator), an interferometer, or the like. In some cases, waveguide 124a-c may be configured to propagate an electromagnetic radiation (EMR).

Still referring to FIG. 1, in some embodiments system 100 may include at least a light source. System may include a plurality of light sources; for instance, system may include at least a first light source and at least a second light source. As used in this disclosure, a “light source” is any device configured to emit electromagnetic radiation, such as without limitation light, UV, visible light, and/or infrared light. In some cases a light source may include a coherent light source, which is configured to emit coherent light, for example a laser. In some cases, a light source may include a non-coherent light source configured to emit non-coherent light, for example a light emitting diode (LED). In some cases, light source may emit a light having substantially one wavelength. In some cases, light source may emit a light having a wavelength range. Light may have a wavelength in an ultraviolet range, a visible range, a near-infrared range, a mid-infrared range, and/or a far-infrared range. For example, in some cases light may have a wavelength within a range from about 100 nm to about 20 micrometers. In some cases, light may have a wavelength within a range of about 400 nm to about 2,500 nm. Light sources may include, one or more diode lasers, which may be fabricated, without limitation, as an element of an integrated circuit; diode lasers may include, without limitation, a Fabry Perot cavity laser, which may have multiple modes permitting outputting light of multiple wavelengths, a quantum dot and/or quantum well-based Fabry Perot cavity laser, an external cavity laser, a mode-locked laser such as a gain-absorber system, configured to output light of multiple wavelengths, a distributed feedback (DFB) laser, a distributed Bragg reflector (DBR) laser, an optical frequency comb, and/or a vertical cavity surface emitting laser. Light source may additionally or alternatively include a light-emitting diode (LED), an organic LED (OLED) and/or any other light emitter. In some cases, light source may be configured to couple light into optical device 120, for instance into at least a waveguide 124a-c.

With continued reference to FIG. 1, sensor device 120 may include at least a sensor 128. Sensor 128 may be optical communication with at least a waveguide 124a-c. Sensor 128 may be configured to detect a variance in at least an optical property associated with the at least a fluid. As used in this disclosure, a “sensor” is a device that detects at least a property as a function of at least a phenomenon. In some cases, a sensor may generate and/or communicate signal representative of the detected property. As used in this disclosure, an “optical property” is any detectable characteristic associated with electromagnetic radiation, for instance UV, visible light, infrared, and the like.

With continued reference to FIG. 1, in some embodiments, sensor may include at least a photodetector. In some cases, sensor 128 may include a plurality of photodetectors, for instance at least a first photodetector and at least a second photodetector. In some cases, at least a first photodetector and/or at least a second photodetector may be configured to measure one or more of first optical output and second optical output, from a first waveguide 124a and a second waveguide 124b, respectively. As used in this disclosure, a “photodetector” is any device that is sensitive to light and thereby able to detect light. In some cases, a photodetector may include a photodiode, a photoresistor, a photosensor, a photovoltaic chip, and the like. In some cases photodetector may include a Germanium-based photodiode. Light detectors may include, without limitation, Avalanche Photodiodes (APDs), Single Photon Avalanche Diodes (SPADs), Silicon Photomultipliers (SiPMs), Photo-Multiplier Tubes (PMTs), Micro-Channel Plates (MCPs), Micro-Channel Plate Photomultiplier Tubes (MCP-PMTs), Indium gallium arsenide semiconductors (InGaAs), photodiodes, and/or photosensitive or photon-detecting circuit elements, semiconductors and/or transducers. Avalanche Photo Diodes (APDs), as used herein, are diodes (e.g. without limitation p-n, p-i-n, and others) reverse biased such that a single photon generated carrier can trigger a short, temporary “avalanche” of photocurrent on the order of milliamps or more caused by electrons being accelerated through a high field region of the diode and impact ionizing covalent bonds in the bulk material, these in turn triggering greater impact ionization of electron-hole pairs. APDs provide a built-in stage of gain through avalanche multiplication. When the reverse bias is less than the breakdown voltage, the gain of the APD is approximately linear. For silicon APDs this gain is on the order of 10-100. Material of APD may contribute to gains. Germanium APDs may detect infrared out to a wavelength of 1.7 micrometers. InGaAs may detect infrared out to a wavelength of 1.6 micrometers. Mercury Cadmium Telluride (HgCdTe) may detect infrared out to a wavelength of 14 micrometers. An APD reverse biased significantly above the breakdown voltage is referred to as a Single Photon Avalanche Diode, or SPAD. In this case the n-p electric field is sufficiently high to sustain an avalanche of current with a single photon, hence referred to as “Geiger mode.” This avalanche current rises rapidly (sub-nanosecond), such that detection of the avalanche current can be used to approximate the arrival time of the incident photon. The SPAD may be pulled below breakdown voltage once triggered in order to reset or quench the avalanche current before another photon may be detected, as while the avalanche current is active carriers from additional photons may have a negligible effect on the current in the diode. At least a first photodetector may be configured to generate a first signal as a function of variance of an optical property of a first waveguide 124a, where first signal may include without limitation any voltage and/or current waveform.

Still referring to FIG. 1, in an embodiment, system 100 may include at least a second photodetector located down beam from at least a second waveguide 124b. At least a second photodetector may be implemented using any device or component suitable for use as at least a first photodetector, as described above. At least a second photodetector may be configured to measure a variance of an optical property of a second waveguide 124b and generate a second signal as a function of the variance of an optical property of a second waveguide 124b. In some cases, at least a first photodetector and/or at least a second photodetector may include a photosensor array, for example without limitation a one-dimensional array. Photosensor array may be configured to detect a variance in an optical property of at least a waveguide 124a-c. In some cases, at least a first photodetector and/or at least a second photodetector may be wavelength dependent. For instance, and without limitation, first photodetector and/or second photodetector may have a narrow range of wavelengths to which each of first photodetector and second photodetector are sensitive. As a further non-limiting example, each of first photodetector and second photodetector may be preceded by wavelength-specific optical filters such as bandpass filters and/or filter sets, or the like; in any case, a splitter may divide output from matrix multiplier and provide it to each of first photodetector and second photodetector. Alternatively or additionally, one or more optical elements may divide output from at least a waveguide 124a-c prior to provision to each of first photodetector and second photodetector, such that each of first photodetector and second photodetector receives a distinct wavelength and/or set of wavelengths. For example, and without limitation, in some cases a wavelength demultiplexor may be disposed between at least a waveguide 124a-c and at least a first photodetector and/or at least a second photodetector; and the wavelength demultiplexor may be configured to separate one or more lights or light arrays dependent upon wavelength. As used in this disclosure, a “wavelength demultiplexor” is a device that is configured to separate two or more wavelengths of light from a shared optical path. In some cases, a wavelength demultiplexor may include at least a dichroic beam splitter. In some cases, a wavelength demultiplexor may include any of a hot mirror, a cold mirror, a short-pass filter, a long pass filter, a notch filter, and the like. An exemplary wavelength demultiplexor may include part No. WDM-11P from OZ Optics of Ottawa, Ontario, Canada. Further examples of demultiplexors may include, without limitation, gratings, prisms, and/or any other devices and/or components for separating light by wavelengths that may occur to persons skilled in the art upon reviewing the entirety of this disclosure. In some cases, at least a photodetector may be communicative with computing device 104, such that a sensed signal may be communicated with computing device 104.

Still referring to FIG. 1, in some embodiments, sensor 128 may be in communication with computing device 104. For instance, sensor 128 may communicate with computing device using one or more signals. As used in this disclosure, a “signal” is any intelligible representation of data, for example from one device to another. A signal may include an optical signal, a hydraulic signal, a pneumatic signal, a mechanical, signal, an electric signal, a digital signal, an analog signal and the like. In some cases, a signal may be used to communicate with a computing device, for example by way of one or more ports. In some cases, a signal may be transmitted and/or received by a computing device for example by way of an input/output port. An analog signal may be digitized, for example by way of an analog to digital converter. In some cases, an analog signal may be processed, for example by way of any analog signal processing steps described in this disclosure, prior to digitization. In some cases, a digital signal may be used to communicate between two or more devices, including without limitation computing devices. In some cases, a digital signal may be communicated by way of one or more communication protocols, including without limitation internet protocol (IP), controller area network (CAN) protocols, serial communication protocols (e.g., universal asynchronous receiver-transmitter [UART]), parallel communication protocols (e.g., IEEE 128 [printer port]), and the like.

Still referring to FIG. 1, in some cases, system 100, sensor 128, and/or computing device 104 may perform one or more signal processing steps on a signal. For instance, system 100 sensor 128, and/or computing device 104 may analyze, modify, and/or synthesize a signal representative of data in order to improve the signal, for instance by improving transmission, storage efficiency, or signal to noise ratio. Exemplary methods of signal processing may include analog, continuous time, discrete, digital, nonlinear, and statistical. Analog signal processing may be performed on non-digitized or analog signals. Exemplary analog processes may include passive filters, active filters, additive mixers, integrators, delay lines, compandors, multipliers, voltage-controlled filters, voltage-controlled oscillators, and phase-locked loops. Continuous-time signal processing may be used, in some cases, to process signals which varying continuously within a domain, for instance time. Exemplary non-limiting continuous time processes may include time domain processing, frequency domain processing (Fourier transform), and complex frequency domain processing. Discrete time signal processing may be used when a signal is sampled non-continuously or at discrete time intervals (i.e., quantized in time). Analog discrete-time signal processing may process a signal using the following exemplary circuits sample and hold circuits, analog time-division multiplexers, analog delay lines and analog feedback shift registers. Digital signal processing may be used to process digitized discrete-time sampled signals. Commonly, digital signal processing may be performed by a computing device or other specialized digital circuits, such as without limitation an application specific integrated circuit (ASIC), a field-programmable gate array (FPGA), or a specialized digital signal processor (DSP). Digital signal processing may be used to perform any combination of typical arithmetical operations, including fixed-point and floating-point, real-valued and complex-valued, multiplication and addition. Digital signal processing may additionally operate circular buffers and lookup tables. Further non-limiting examples of algorithms that may be performed according to digital signal processing techniques include fast Fourier transform (FFT), finite impulse response (FIR) filter, infinite impulse response (IIR) filter, and adaptive filters such as the Wiener and Kalman filters. Statistical signal processing may be used to process a signal as a random function (i.e., a stochastic process), utilizing statistical properties. For instance, in some embodiments, a signal may be modeled with a probability distribution indicating noise, which then may be used to reduce noise in a processed signal.

With continued reference to FIG. 1, system may include at least a sensor interface 132. Sensor interface 132 may be configured to wet at least a waveguide 124a-c with at least a fluid contained within or otherwise acted upon by microfluidic device 108. As used in this disclosure, a “sensor interface” is an arrangement permits a sensor device to be in sensed communication with a microfluidic device. In some embodiments, a sensor interface may include an optical interface. As used in this disclosure, an “optical interface” is an arrangement permits a sensor device to be in sensed communication with a microfluidic device. In one embodiment, sensor device may be coupled to a sensor interface 132 that includes a porous membrane (e.g. nitrocellulose, paper, glass fiber, etc.) that promotes capillary flow. In some cases, a surface of sensor device may be modified with hydrophilic chemistry, for instance by way of silanes, proteins, or another treatment (or may already be hydrophilic) in the sensing region. For example, one or more of sensor device and sensor interface 132 may be configured such that liquid wicks from a porous membrane to a surface of sensor device as it flows through the membrane.

Still referring to FIG. 1, in some embodiments, at least a sensor interface 132 may include a flow cell. As used in this disclosure, a “flow cell” is a component of or associated with a microfluidic device that contains and provides access to a fluid or a flow of a fluid for a sensor interface arrangement. In some cases, a flow cell may effectively increase an area over which a fluid flows, thereby increasing access to the fluid for optical sensing. In some cases, a flow cell may include micro-posts. In some cases, a flow cell may include a plurality of micro-posts. As used in this disclosure, “micro-posts” are small scale (e.g., sub-millimeter) protrusions which breakup a flow path. In some cases, a micro-post property may be varied in order to affect a flow property. Exemplary non-limiting micro-post properties include pitch, micro-post width (e.g., diameter), micro-post arrangement (e.g., hexagonal), micro-post size (e.g., column), micro-post height, number of micro-posts (total, in a row, in a column, etc.), and the like.

Still referring to FIG. 1, in some embodiments, at least a sensor interface 132 may include a porous membrane. As used in this disclosure, a “porous membrane” is a material with a plurality of voids. In some cases, a porous membrane may have at least a membrane property selected to achieve at least a flow property. As used in this disclosure, a “membrane property” is an objective characteristic associated with a porous membrane. Exemplary non-limiting membrane properties include pore size, porosity, measures of hydrophilicity, measures of surface tension, measures of capillary action, material, and the like. In some embodiments, a porous membrane 132 interfacing with sensor device 120 and microfluidic device 108 may provide several advantages. Exemplary non-limiting advantages include: (1) a porous membrane 132 connecting two segments of a channel may provide fluidic communication, connecting one segment of the channel to another; (the porous membrane 132 may, thus, carry reagents and/or samples in solution, and open the channel to an outside environment while maintaining fluidic flow to the microfluidic system) (2) a porous membrane may eliminate need for a gasket (which may leak and result in poor yield); (3) a porous membrane may help control flow properties; (for example, flow rate within microfluidic device 108 may be determined by pore size, pore density, membrane material, and porous membrane dimensions) (4) a porous membrane strip 132 interfacing sensor chips 120 to microfluidic system 108 may require less precision; (5) a porous membrane strip may be compatible with a passive microfluidic system; and (6) a porous membrane strip may help facilitate passive fluid flow through channels at a controlled flow rate.

Still referring to FIG. 1, microfluidic device 108 may include at least a channel. As used in this disclosure, a “channel” is a reservoir having one or more of an inlet (i.e., input) and an outlet (i.e., output). Channels may have a submillimeter scale consistent with microfluidics. Channels may have channel properties which affect other system properties (e.g., flow properties, flow timing, and the like). As used in this disclosure, “channel properties” are objective characteristics associated with channels or a microfluidic device generally. Exemplary non-limiting channel properties include width, height, length, material, surface roughness, cross-sectional area, layout, and the like. In some cases, development of microfluid channel layout, selection of passive flow device 116, and sensor interface 132 may need to be performed in an iterative design process as each parameter is interdependent with important system properties (e.g., flow properties and flow timing). In some embodiments, aspect ratios of chambers (e.g., reservoirs), fluidic resistances (controlled by dimensions) of channels between the chambers (and interface 132), and passive flow component 116 parameters (e.g., capillary pressure of a capillary pump) may be tuned to affect one or both of timing and flow of fluid. In some embodiments, channels of microfluidic device (i.e., cartridge) may be hydrophilic, for example through coating, to ensure flow. Alternatively or additionally, microfluidic device 108 may include a hydrophilic material, such as without limitation polymethyl methacrylate (PPMA).

In some cases, a reagent chamber may be placed such that the sensor reaction chamber is between the reagent chamber and the sample chamber.

Still referring to FIG. 1, in some embodiments, at least a passive flow device 116 may include a capillary pump. As used in this disclosure, a “capillary pump” is a passive flow device which induces fluid flow through capillary action. In some cases, pumping achieved with a capillary pump may not require external actuation power. In some cases, a capillary pump may include one or more of glass capillaries and porous membrane (e.g., including nitrocellulose paper and synthetic paper). In some cases, capillary pumping may be used in lateral flow testing. In some cases, a capillary pump may induce a constant pumping flow rate, which is independent of fluid viscosity and surface energy. In some cases, passive flow device 116 may include one or more of an absorbent pad and/or another capillary pump located after a sensor interface (i.e., reaction chamber) 132.

Still referring to FIG. 1, in some embodiments, predetermined flow properties may be selected to achieve a predetermined flow timing. As used in this disclosure, “flow timing” is any time-dependent property associated with a flow of fluid. For instance, in some cases, flow timing may include a duration for a flow to reach, pass through, or otherwise interact with an element of microfluidic device. In some cases, predetermined flow timing may be configured to cause a first fluid to wet at least a waveguide 124a-c at a first time and a second fluid to wet the at least a waveguide 124a-c at a second time. In some cases, second time may occur a predetermined time after a first time. In some cases, first fluid may include a sample, and second fluid may comprise a reagent.

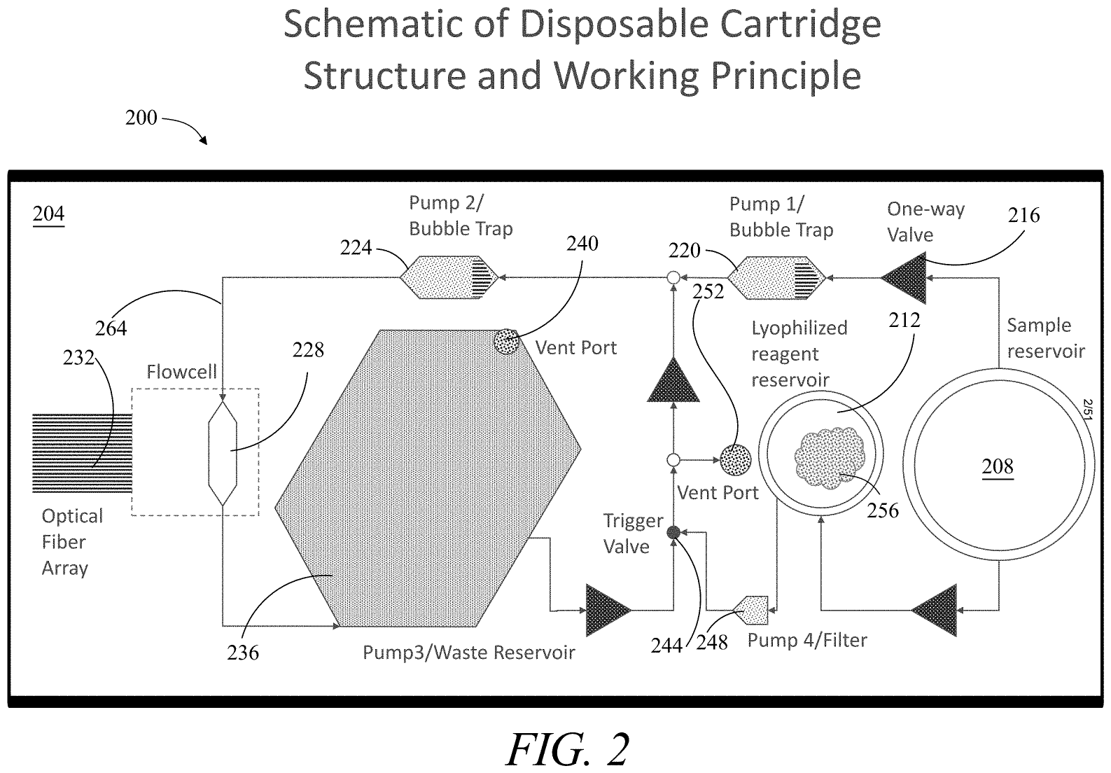

Now referring to FIG. 2, a schematic diagram of an exemplary embodiment of a microfluidic device 200 is shown. Device 204 may include a substrate 204 that various components of device 200 may be mounted to. Substrate 204 may be composed of various materials, such as glass, silicon, and the like. In one or more embodiments, device 200 may be fabricated using various processes, such as, for example, photolithography, injection molding, stamping processes, and the like. In various embodiments, substrate 204 may be substantially planar. In some embodiments, components of device 200 may be built on a substrate using, for example, photosensitive polymers or photoresists (e.g., SU-8, Ostemer, and the like). In other embodiments, components of device 200 may be molded or stamped into polymers (e.g., PMMA). In other embodiments, components of device 200 may be built into or on substrate 204 using etching processes, in which channels, reservoirs, capillary pumps, and valves may be built by removing materials from substrate 204. In nonlimiting embodiments, the entire microfluidic system may be fabricated on substrate 204, sealed with a cover plate, where holes are drilled and aligned with certain microfluidic components, such as one or more reservoirs.

Continuing with reference to FIG. 2, in some embodiments, device 200 may include a sample reservoir 208 configured to receive a biological sample, such as a biological extraction, from an organism, such as a person. In some examples, capillary pumps may work together to drive flow through the microfluidic channels as soon as a sample (e.g. aqueous sample) is added into the sample reservoir 208. A sensor may be in contact with the flow cell in order to monitor reactions between samples and reagents. In some examples, output of the sensor is transferred to a reader where analog signals are analyzed and converted to digital output. In FIG. 2, the sensor is illustrated as a photonic device (e.g., optical fiber array). In some cases, device 200 may include a lyophilized reagent reservoir, a chamber to hold dried reagents, which may be covered with protection film at atmosphere pressure.

Continuing with reference to FIG. 2, in some embodiments, device 200 may include a sequential flow (as indicated by directional arrows) that allows fluids to traverse through various channels 264 of the microfluidic system of device 200. In some cases, device 200 may include a one-way valve 216 such as, for example, a Tesla valve. In some cases, device 200 may include a flow cell 228 that functions as an interface to a sensor component, and trigger valve(s) that may open a specific channel based on certain conditions (e.g. a pre-determined timing). Additionally, a vent port may allow air to be released or ventilated when fluid is filled into chamber or channels. In some cases, a vent port may help ensure no internal air pressure is built up or accumulated within system.

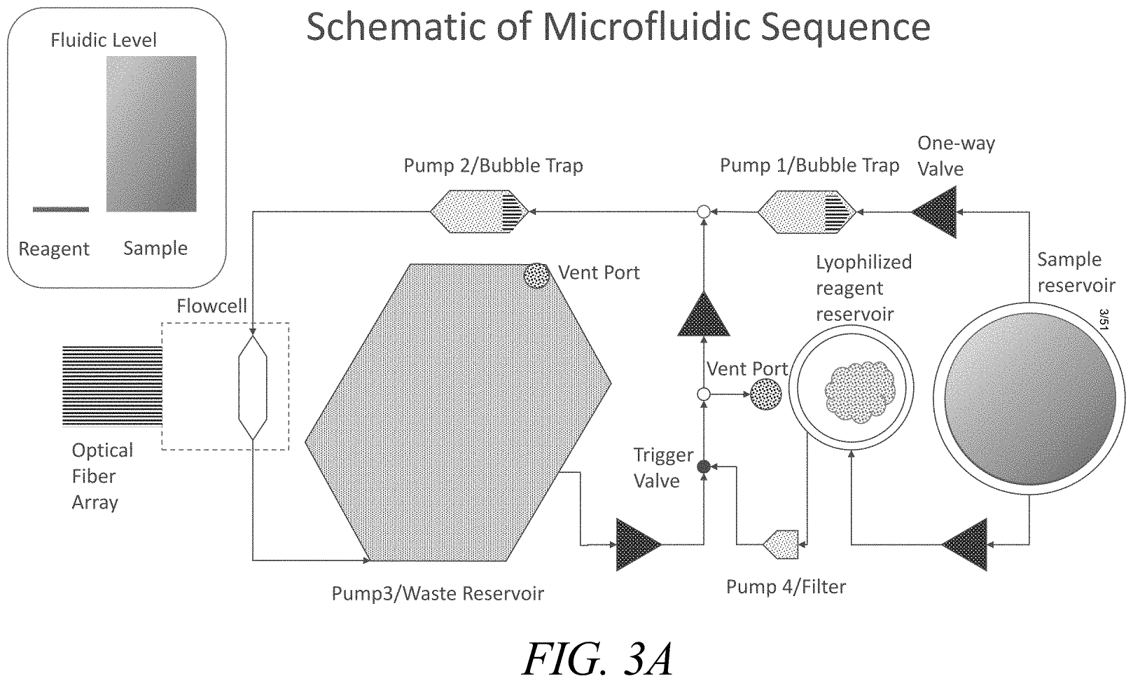

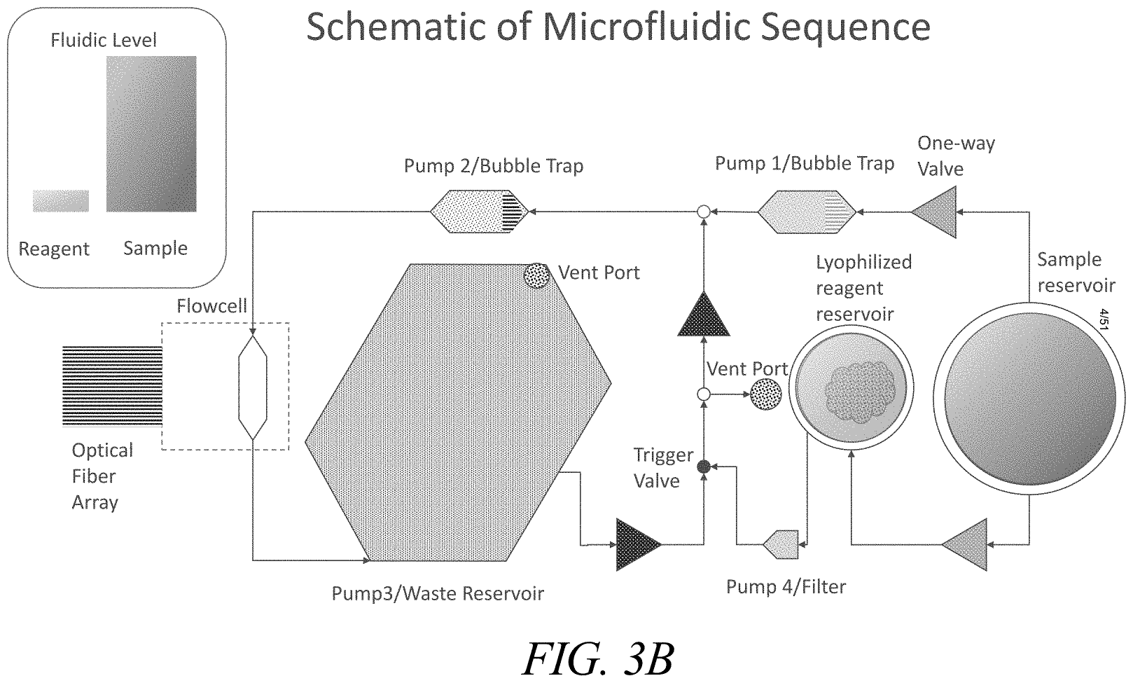

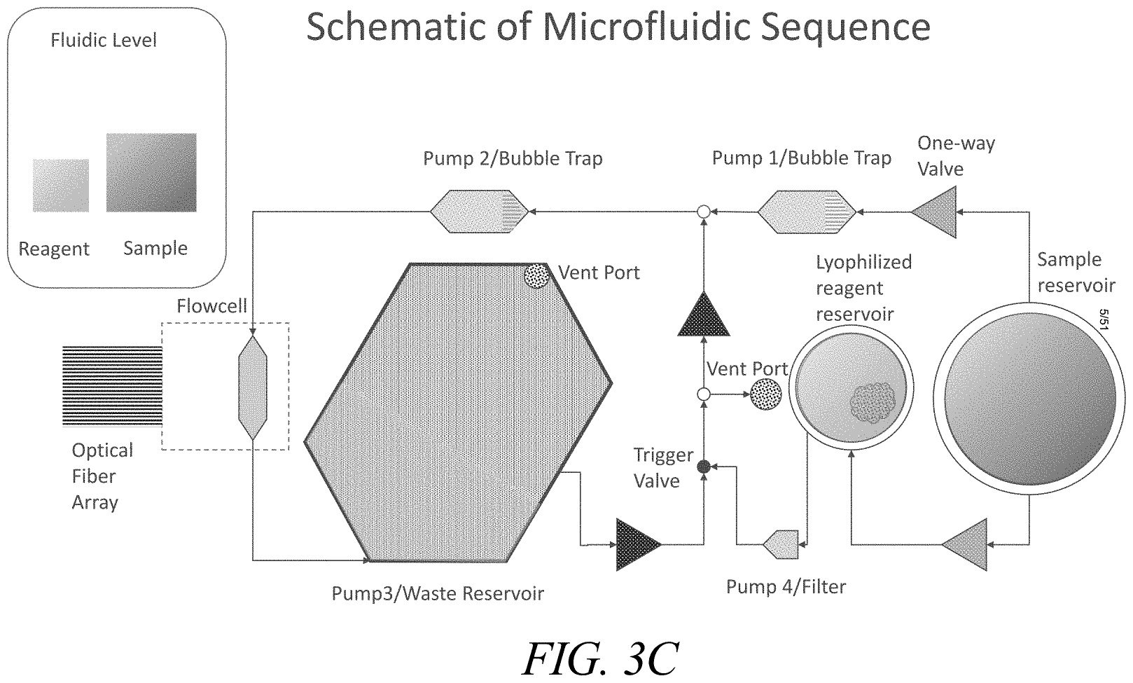

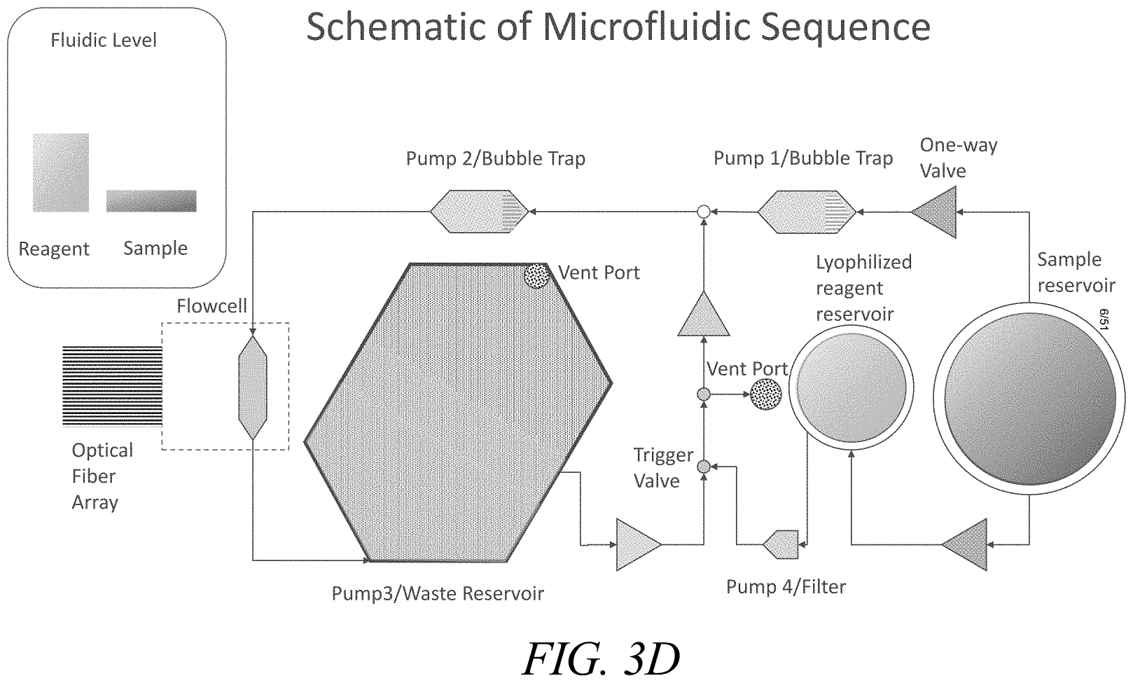

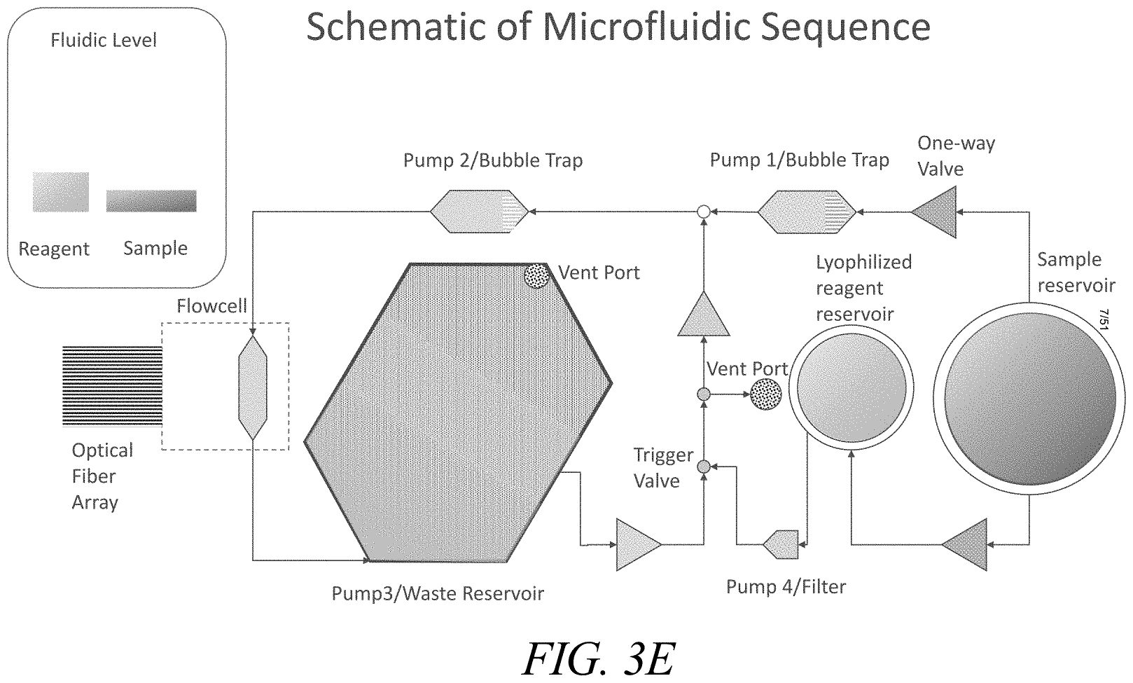

Now referring to FIGS. 3A-3E, schematic diagrams illustrating an exemplary sequential flow of a microfluidic system or device 200 are shown. A method of analysis of a sample may be understood with reference to FIGS. 3A-3E. In some cases, analysis begins by adding a sample solution 260 into sample reservoir 208, then the rest of the process may be fully driven by microfluidic components of device 200. FIG. 2A shows an initiating moment when a sample 260 is added into sample reservoir 208. After the sample is added into sample reservoir 208, sample 260 may begin to flow, for instance in two directions, as indicated by directional arrows. A first direction of flow 264 of sample 260 may be toward first pump 220. First pump 220 may include a passive flow device. In some embodiments, first pump 220 may act as a bubble trap device. A small amount of gas bubbles (e.g., air), if present in sample 260, is trapped within bubble trap without interrupting a main flow of sample solution 260. A second flow direction 268 of sample solution 260 may be towards a reagent reservoir 212. Reagent reservoir 212 may contain dried or lyophilized reagents, such as enzymes, antibodies, biomarkers, proteins, and the like. At this stage, sample level inside the sample reservoir may be considered at a maximum.

FIG. 3B shows sample passing through first pump 220 and going into reagent reservoir, where a dried reagent starts to dissolve. In some cases, an amount of reagent liquid flows into pump 4, which also may also serve as bubble trap and/or filter; however, the liquid stops at the point of trigger valve.

FIG. 3C shows a moment when sample solution passes sensor (via a flow cell) and goes into pump 3, which may also serve as a waste reservoir. Flow towards reagent reservoir may continue. Backflow into sample reservoir may be prevented in one or more ways (e.g., (1) a one-way valve may create a high resistance to fluidic flow in an opposite direction; and/or (2) sample level or pressure inside the sample reservoir may be higher than a level of reagent solution). In some cases, waste sample may only fill a front portion of the waste reservoir.

FIG. 3D shows a moment when waste reservoir may be filled above a certain capacity (e.g., half) by waste solution, and the waste solution passes an entry point of a trigger channel. In some examples, solution may flow into trigger channel, passing by trigger valve (triggering the trigger valve to open). Reagent solution may be released, upon trigging of trigger valve, into a trigger channel. Along trigger channel, there may be two one-way valves. In some cases, one one-way valve prevents reagent solution flowing into waste reservoir and a second one-way valve may modulate sample solution flow into the trigger channel (for example, completely eliminating it or keeping it at a level, flow, or volume that would inadvertently trigger the trigger valve).

FIG. 3E shows a moment when reagent solution passes by sensor. In some examples, when reagent chamber is empty, microfluidic analysis may be complete. Additionally or alternatively, when flow time reaches a certain threshold (e.g., sensor has completed stages of signal acquisition) analysis is complete and the microfluidic sample may be discarded.

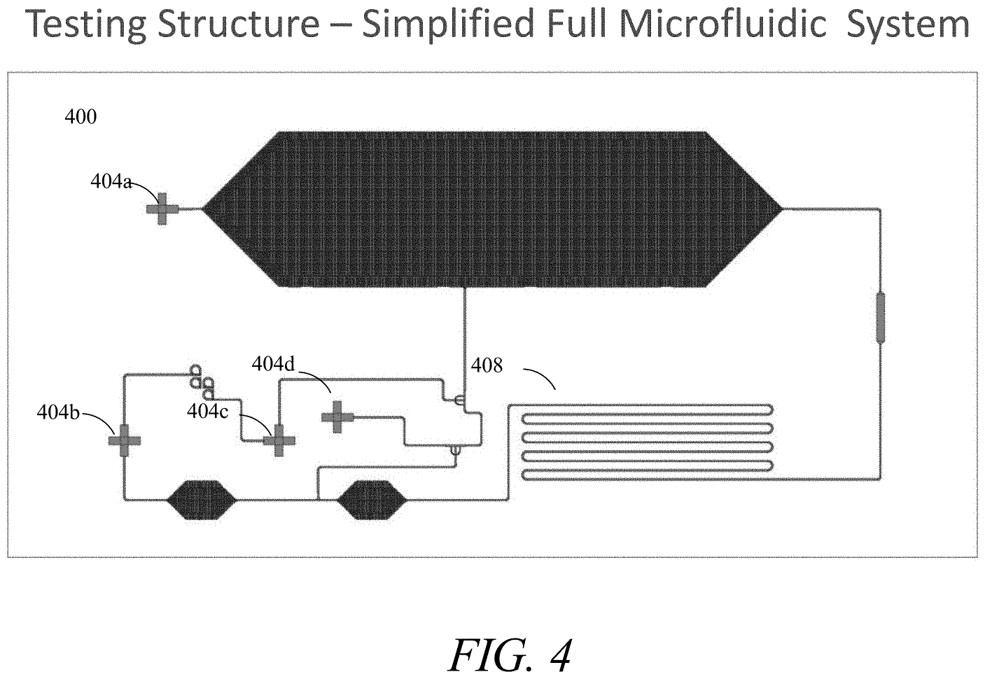

FIG. 4 shows an exemplary embodiment of a microfluidic device 400 that may be fabricated on a chip that is, for example, a size of 25 mm×12.5 mm). Microfluidic device 400 may include locating points 404a-d (i.e., datums), where a cover plate may be aligned to. Microfluid device 400 may include a buffer zone 408. In some cases, buffer zone 408 may modify a channel parameter, such as length to affect a flow or timing parameter. For example, buffer zone 408 may introduce a delay for fluid (e.g., sample solution). Alternatively or additionally, buffer zone 408 may retain fluid (e.g., sample solution inside the buffer zone) until a ventilation port is opened to trigger a flow sequence to start.

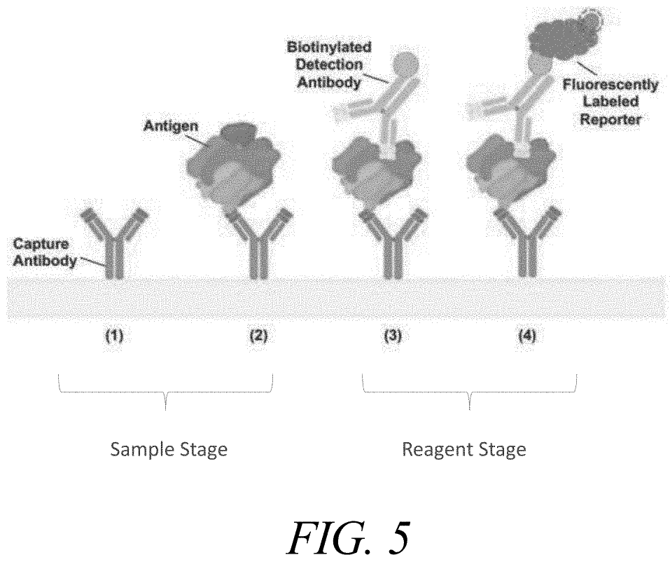

FIG. 5 shows an example detection sequence and biological reaction on a surface of a photonic device (e.g., waveguide) for a biological sample (e.g., virus, antigen, or the like). For example, a reaction may occur at a surface of a sensor device wherein an antibody is pre-mobilized onto an optical surface. As used in this disclosure, “optical surface” may include any surface that is optically communicative, for instance a surface of a waveguide. A chemical reaction may occur with flow cell and/or on optical surface. In some cases, a functional reporter (e.g., antibody bonded with gold nanoparticles, conjugate) may be added to fluid (e.g., sample) as a reagent. In some cases, functional reported may react with antigen, thus increasing a variance in an optical property detectable by sensor device and sensor. In some cases, variance of an optical property may serve as a confirmation for presence of antigen in a test sample. In order to conduct an assay such as a sandwich immunoassay, ELISA, nucleic acid affinity assay, enzymatic assay or other biochemical assay a sequence of one or more reagents may be required to be flowed over a surface of the surface-based sensor (surface-based sensors may be optical, fluorescent, electrical magnetic, and the like).

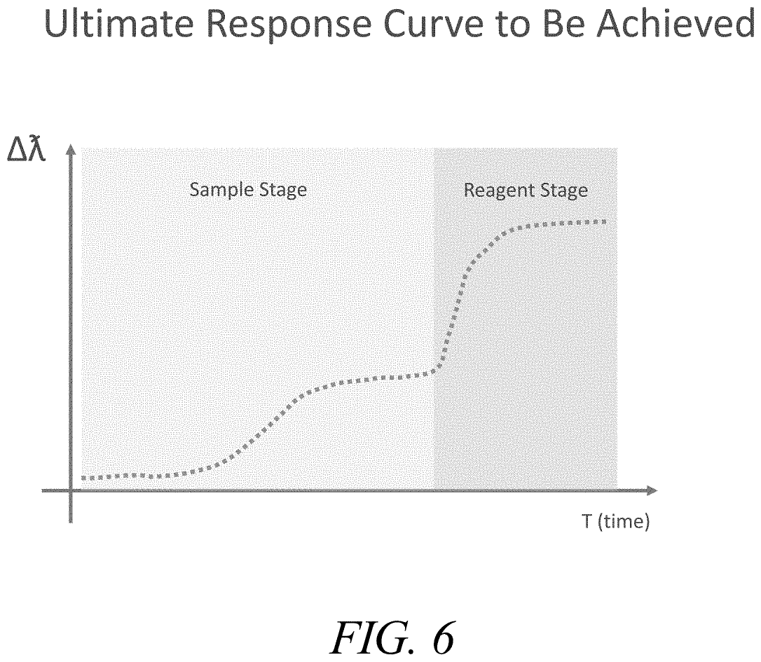

FIG. 6 illustrates an example sensor response curve having a sample stage and a reagent. On a vertical axis signal is shown in arbitrary units. Signal may be representative of an optical property (e.g., change in wavelength). On a horizontal axis time is shown in arbitrary units. Two stages of flows are shown along horizontal axis: (1) sample stage; and (2) reagent stage. As illustrated by sensor response curve, initial sensitivity during sample stage may be increased during a reagent stage, for instance where the reagent contains a conjugate.

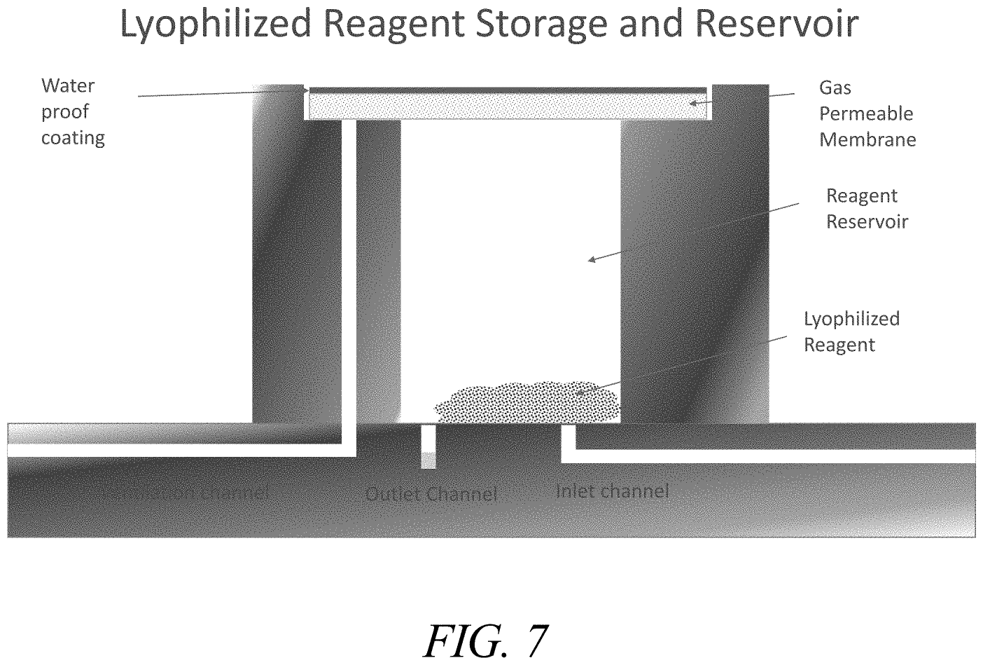

FIG. 7 shows a non-limiting example of a reagent reservoir and a microfluidic system. In some cases, reagent reservoir may include one or more of a waterproof coating, a gas permeable membrane, lyophilized reagents as well as connections to ventilation, outlet, and inlet channels.

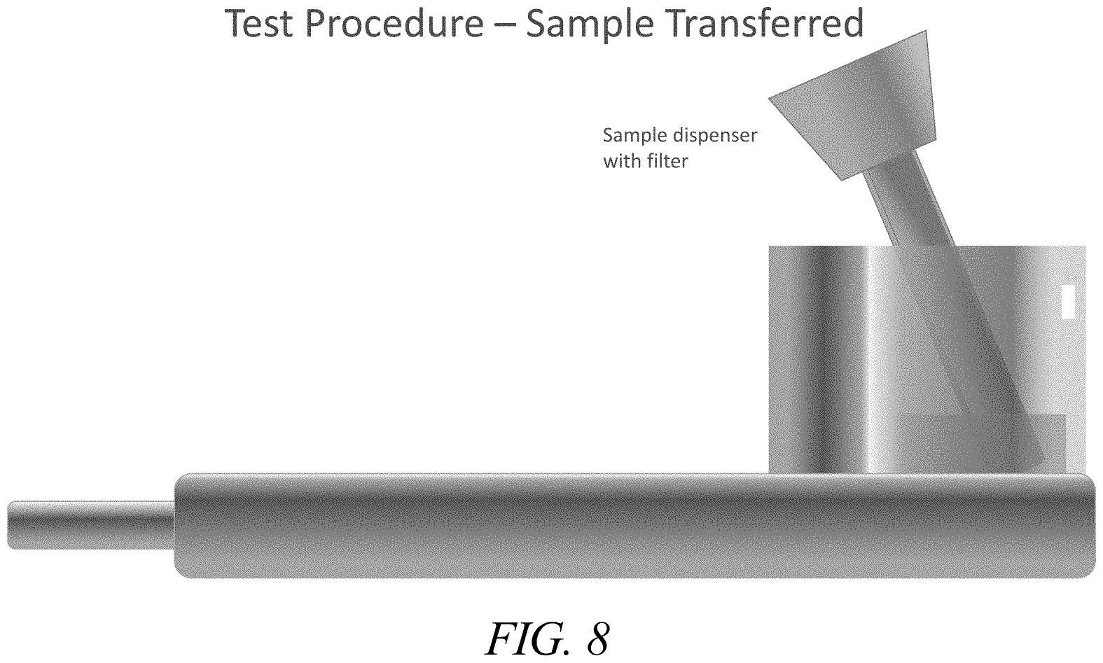

FIG. 8 shows an exemplary testing procedure, according to some embodiments. In some cases, a sample may be injected into sample reservoir via a sample dispenser. In some cases, a sample dispenser may include a filter.

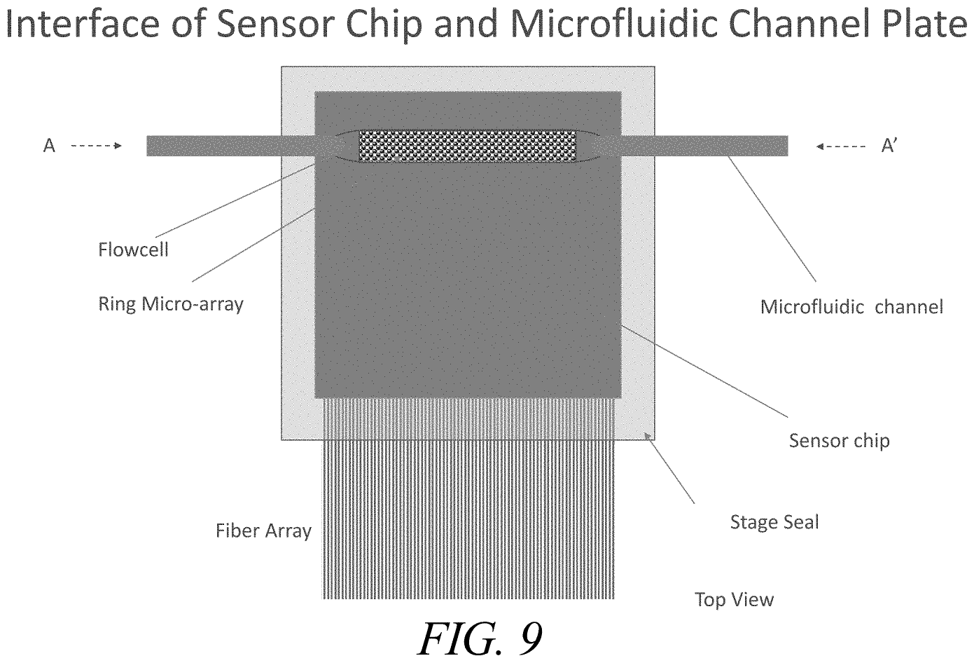

Referring now to FIG. 9, a top-down view of an exemplary system 100 is illustrated. A sensor device may be mounted onto microfluidic cartridge. In some cases, system 100 may include a flow cell, a ring micro-array, a fiber array, a stage seal.

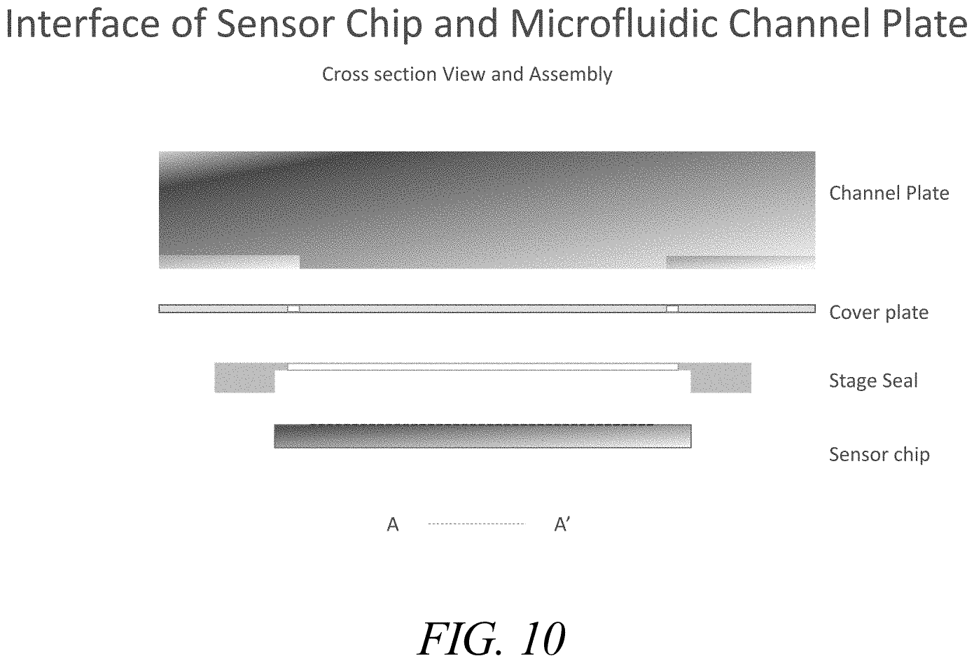

Referring now to FIG. 10, a cross-sectional view of an exemplary system 100 is illustrated, according to some embodiments. In some cases, system 100 may include a channel plate, cover plate, stage seal, and sensor device (i.e., sensor chip).

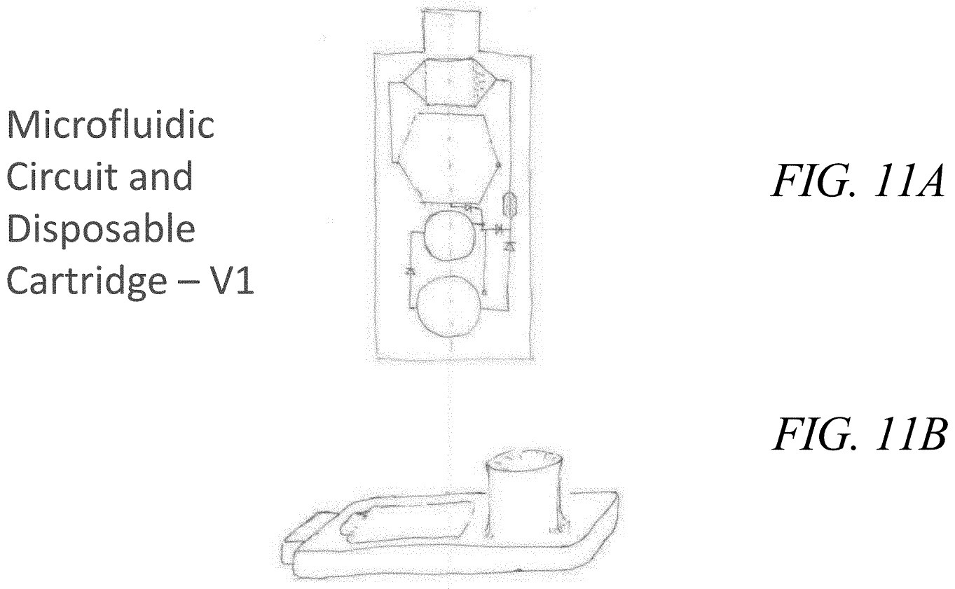

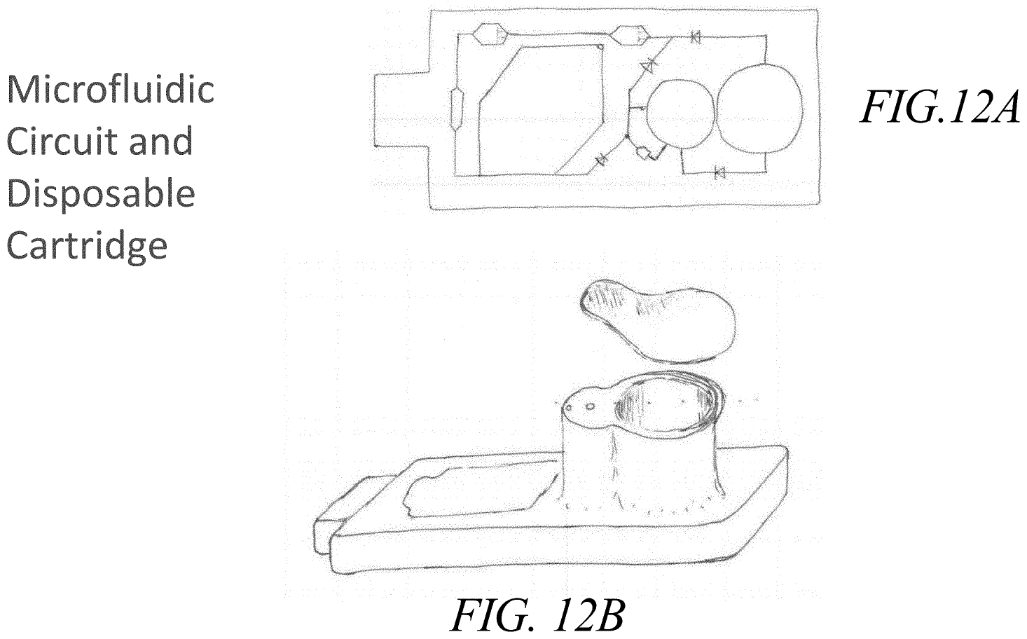

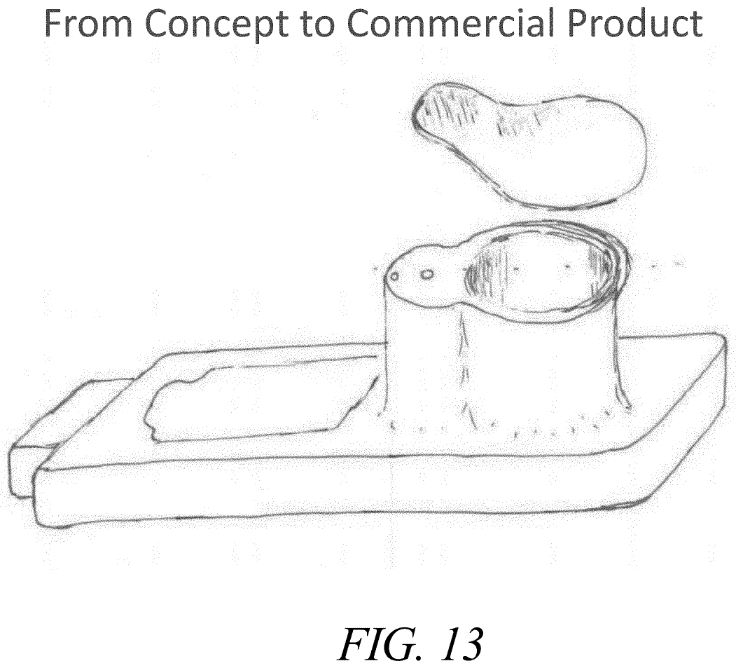

Referring now to FIGS. 11A-B, 12A-B, and 13 additional non-limiting illustrative systems for sensing using passive flow 100 are illustrated, according to some embodiments.

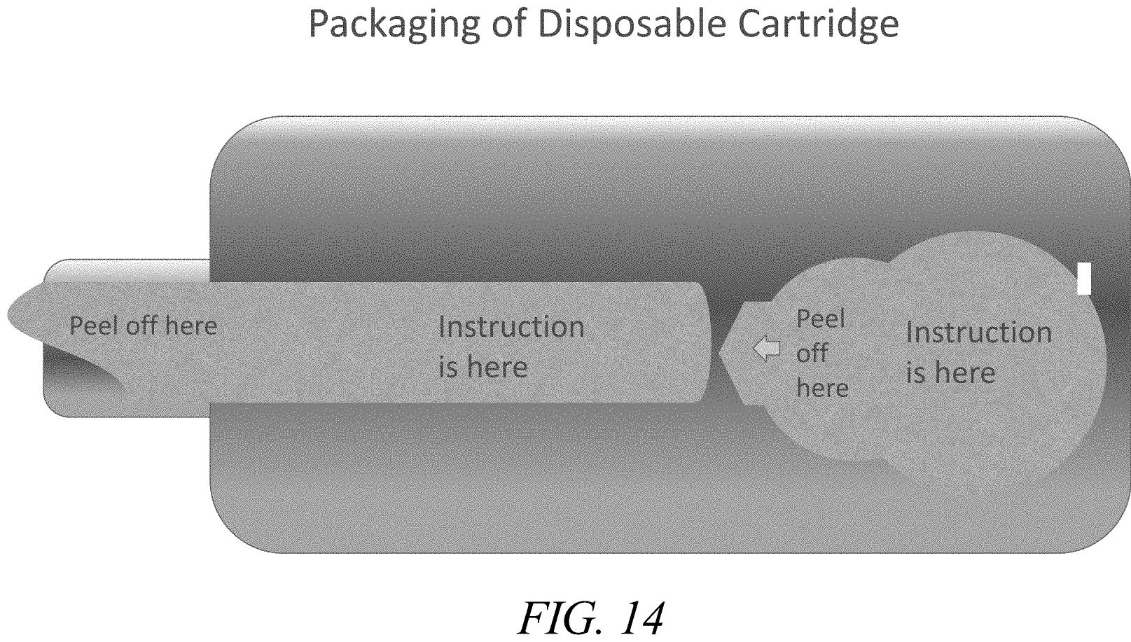

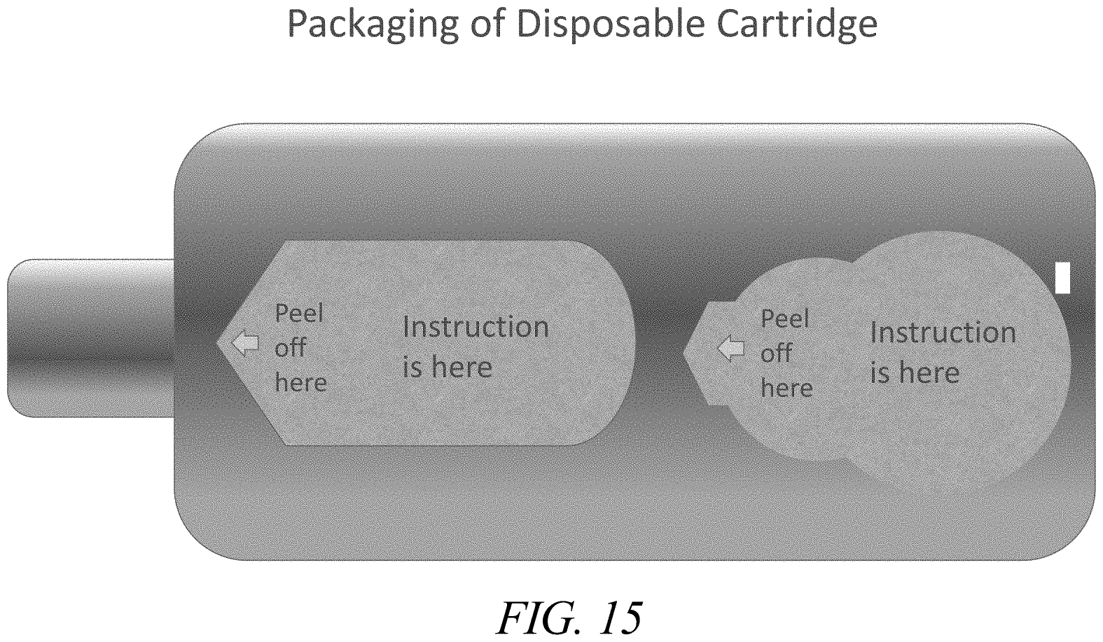

Referring now to FIGS. 14 and 15, non-limiting illustrative packaging examples for system 100 are shown, according to some embodiments having packaging installed. In some cases, packaging may include peel off labels and instructions.

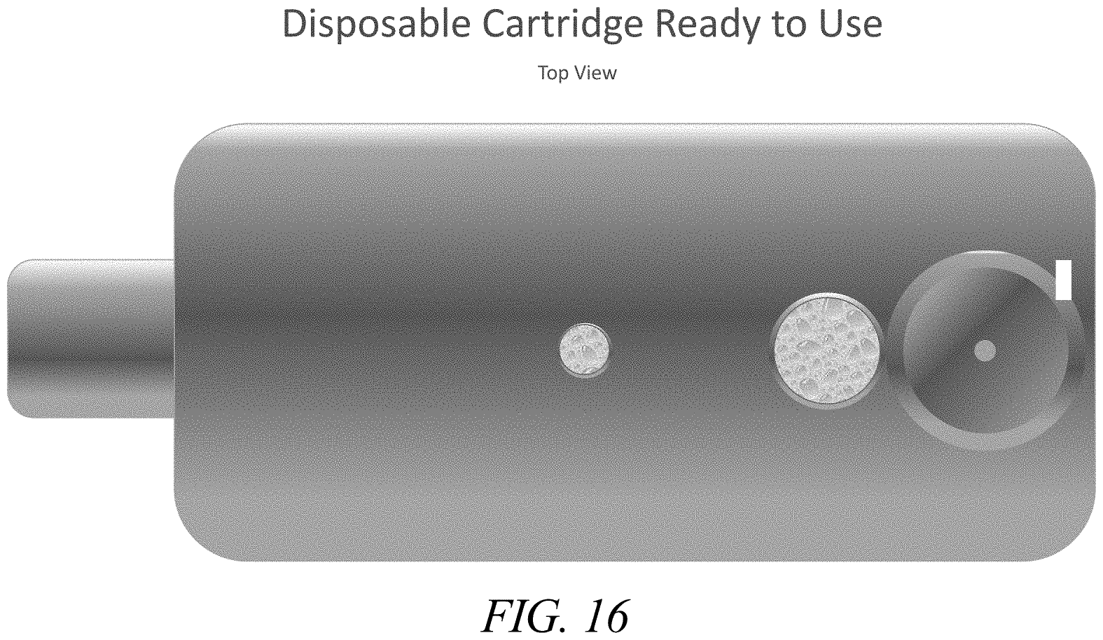

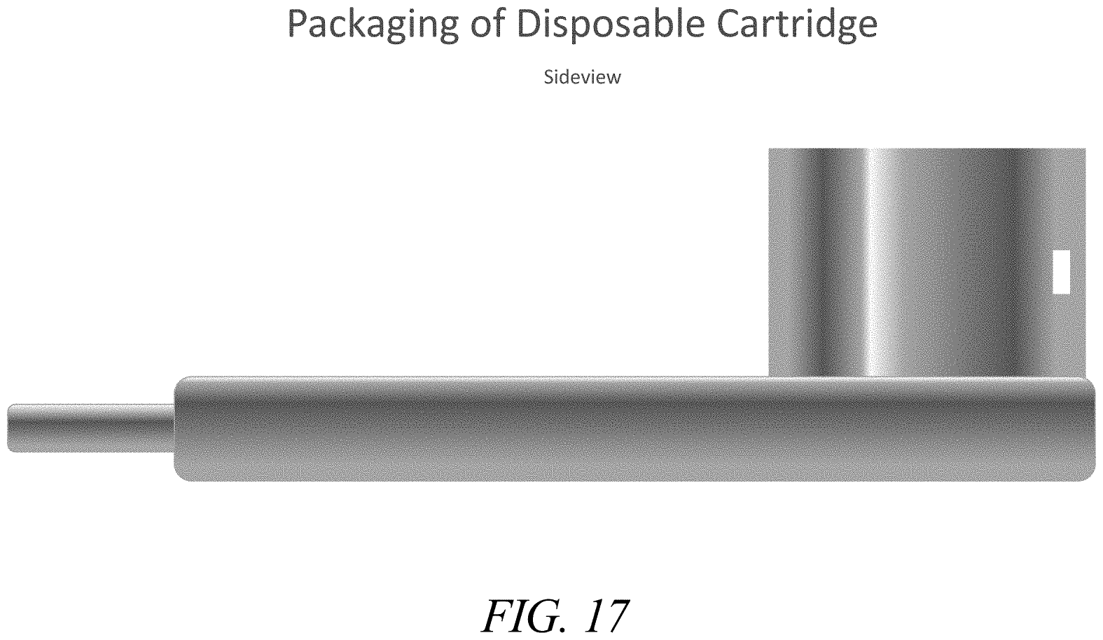

Referring now to FIGS. 16 and 17, non-limiting examples showing a system 100 ready for use are shown, according to some embodiments. FIG. 16 illustrates a top view of system 100. FIG. 17 illustrates a cross-sectional view of system. In some cases, system 100 in a ready for use state, includes a system having packaging items removed.

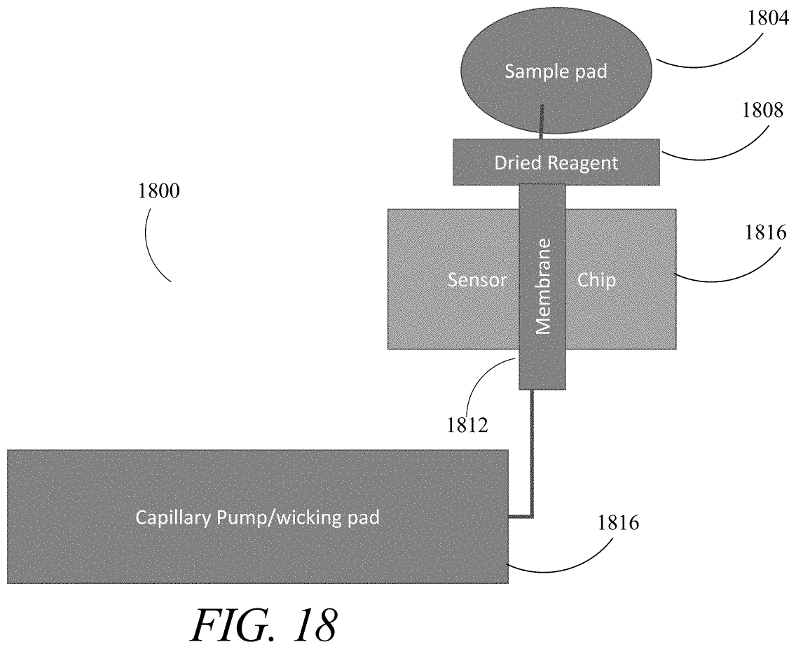

Referring now to FIG. 18, an exemplary system for sensing fluid using passive flow 1800 is shown by way of a block diagram. System 1800 may include a reservoir 1804. In some cases, reservoir 1804 may include a sample pad. Sample pad 1804 may be in fluidic communication with a reagent container 1808 (e.g., reservoir, channel, well, pad, conjugate pad, or the like) configured to store a reagent. Reagent container 1808 and reservoir 1804 may be in fluid communication with a sensor interface 1812. In some cases, sensor interface 1812 may include a porous membrane. Porous membrane 1812 may be in fluidic communication with a passive flow device 1816. Passive flow device 1816 may include a capillary pump 1816, wicking pad 1816, or the like. System 100 may include a lateral flow assay, where detection may be performed on a sensor device 1820 which is wetted with fluid using porous membrane 1812.

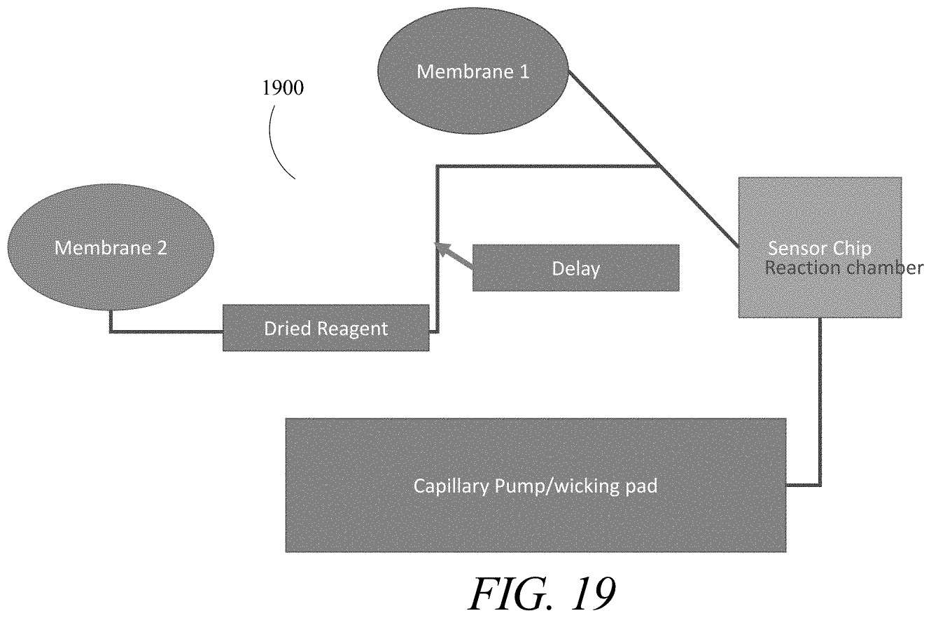

Referring now to FIG. 19, another exemplary embodiment of a system 1900 for fluid sensing using passive flow is illustrated by way of a block diagram. In some embodiments, system 1900 may be split, thereby providing multiple reservoirs (Membrane 1 and Membrane 2). For instance, in some cases either a user and/or a mechanical splitter in system 1900 may operate the system 1900 such that it wets two membranes. In some cases, flow from these two membranes may be joined at a point preceding one or more of a sensor interface (e.g., reaction chamber) and/or sensor device. In some cases, a first membrane (Membrane 1) has a shorter fluidic path, and a second membrane (Membrane 2) has a longer fluidic path and/or a slower wick time, such that fluid from the second membrane arrives to a junction later than from the first membrane. In some cases, a dried reagent may be located within a fluidic path between on one or both of fluidic paths extending from each reservoir. By predetermining locations for reagents, delay times, channel properties, flow properties, and the like sequencing of assay steps may be accomplished. In some embodiments, this concept can be extended to more than two reservoirs to achieve additional steps in an assay.

### Exemplary Assembly

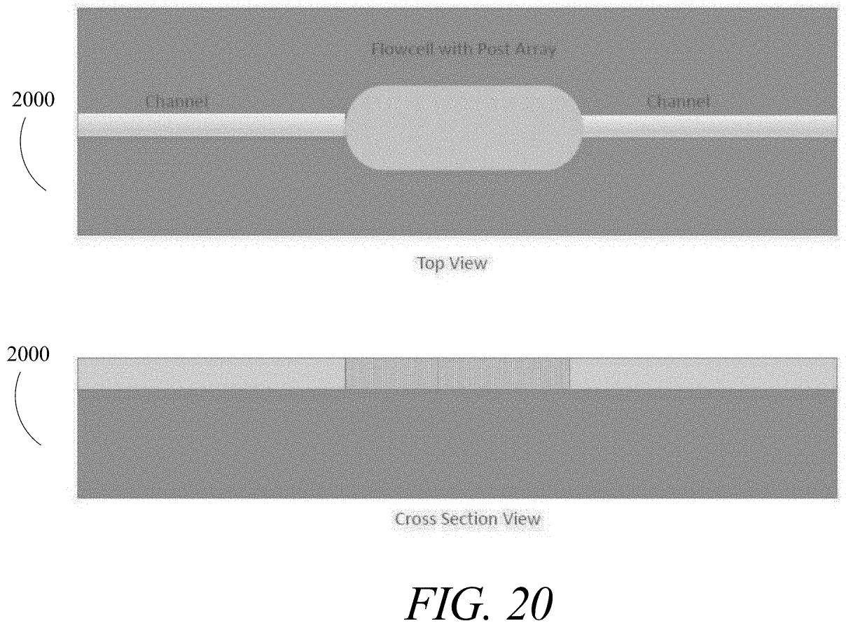

Referring now to FIG. 20, an exemplary sensor interface 2000 is shown in a top view and a cross-sectional view. In some embodiments, sensor interface 2000 may include a microfluidic system fabricated using closed channels (i.e., flow cell), for instance instead of (or in addition to) porous membranes. In some cases, sensor interface 2000 may include a flow cell combined with one or more porous membranes. Unless sensors are built pre-integrated together with a microfluidic system, sensors need to be assembled onto a microfluidic system such that the sensor has contact with fluidic reagents inside microfluidic system (e.g. to facilitate detection of biological samples).

With continued reference to FIG. 20, sensor interface 2000 may include a flow cell. In some cases, channels and flow cell may be formed on a planar surface of an injection molded part, made with patterned laminates, a 3D printed block, or the like. Flow cell may be formed with an array of micro posts. In some cases, micro posts may serve one or more functions, which may be related to one or more micro post properties (e.g., height, width, pitch, arrangement, and the like). In some cases, an array of micro posts may function as a passive flow component, such as a capillary pump due to fluidic surface tension. In other words, in some cases, surfaces of micro posts may continuously draw fluid from an inlet channel, thereby wetting micro post surfaces with a fluid (e.g., fluidic film). Additionally or alternatively, micro post structure may support one or more additional components, such as a sensor interface and/or sensor device. For instance, micro posts may support a porous membrane, thereby preventing the porous membrane from blocking a channel (and interrupting fluidic flow).

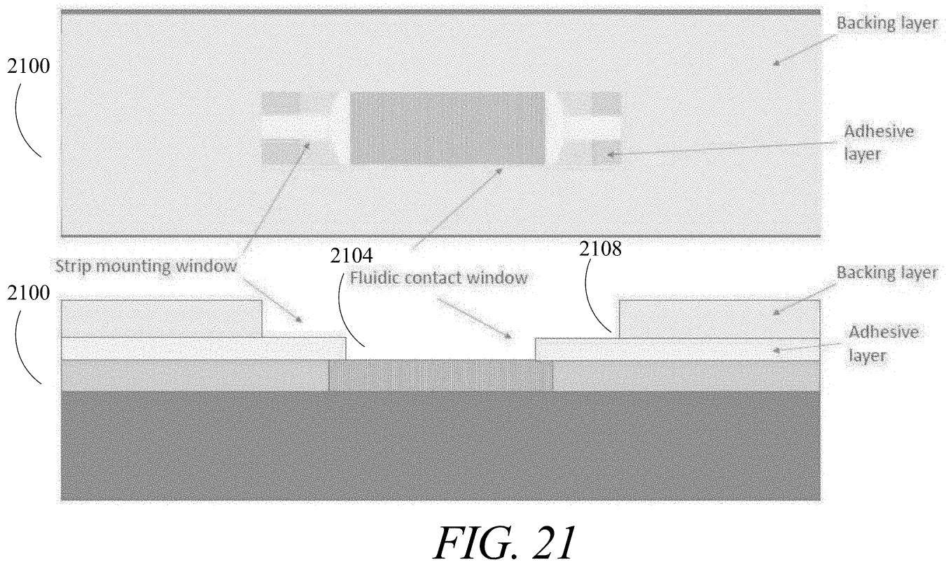

Referring now to FIG. 21, an assembly 2100 for a system for sensing a fluid using passive flow is illustrated by way of a block diagram, having both a top view and a cross-sectional view. In some embodiments, an assembly 2100 may include a sensor interface, including a porous membrane strip that provides an interface between at least a surface of a sensor device and fluid contained within a microfluidic system. In some cases, a layer of tape (e.g., pressure sensitive tape with one side adhesive coating) may be cut with a double window layout, as shown in FIG. 21. Tape may consist of a triple-layer of adhesive-backing-adhesive film. A smaller window 2104 may be utilized for contacting a porous membrane strip to a micro post array. In some cases, porous membrane may absorb fluid and then transfer the fluid to a downstream channel. A larger window 2108 may include a backing layer that leaves an exposed adhesive layer surrounding an open window. In some cases, cut-off tape may be placed over a channel plate of microfluidic device. In some examples, tape may seal channels (e.g., from atmosphere) but exposes only the flow cell area.

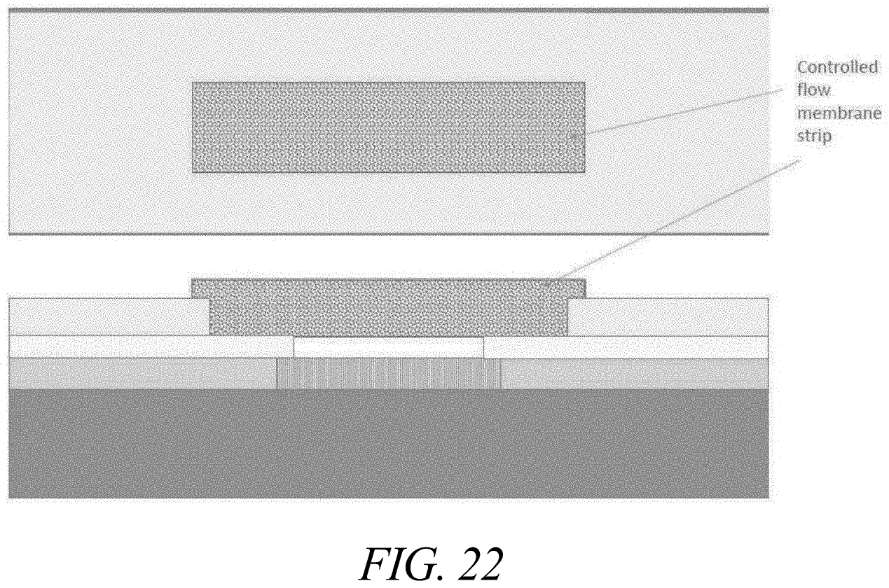

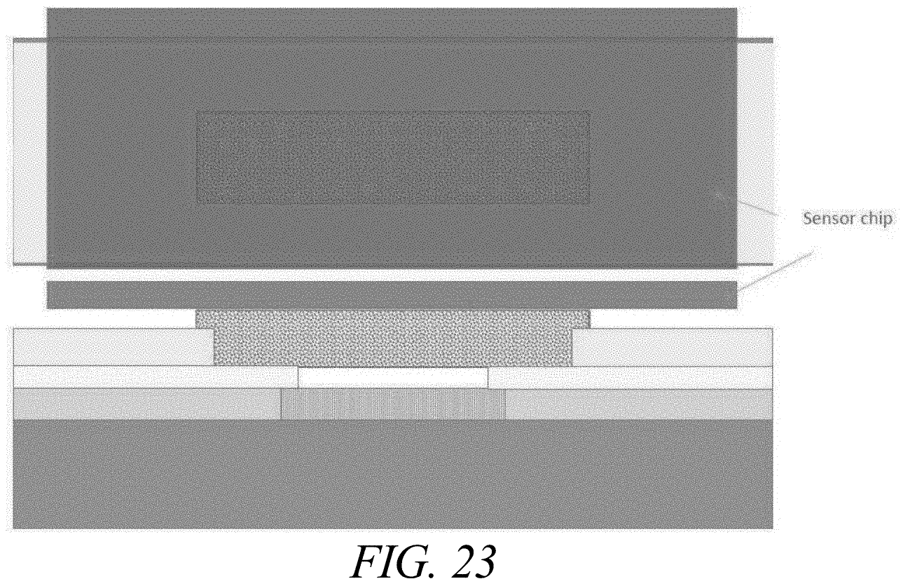

Referring now to FIG. 22, in some embodiments, a porous membrane strip may be cut to fit a size of larger window opening 2108 of tape. Porous membrane strip may, in some cases, be secured by exposed adhesive coating of tape. In some embodiments, entire porous membrane strip may be placed overflow cell, such that it is in contact with a micro post array of the flow cell. In some cases, after assembling assembly 2100, porous membrane strip may be in contact with a top of the posts of a micro post array of flow cell.

Referring now to FIG. 23, in some examples, a sensor chip (i.e., sensor device) may then be placed proximate with porous membrane strip. In some cases, at least a surface of sensing device may be placed in contact with porous membrane strip, as shown in FIG. 23. In some cases, an area of porous membrane strip may be larger than a sensor area (e.g., surface area) of sensor device, such that precision alignment between the porous membrane strip and sensor device may not be necessary. In some embodiments, assembly 2100 may be secured by clamping sensor chip, tape, and porous membrane strip, microfluidic device (i.e., channel block) together.

### Exemplary Microfluid Device Layouts

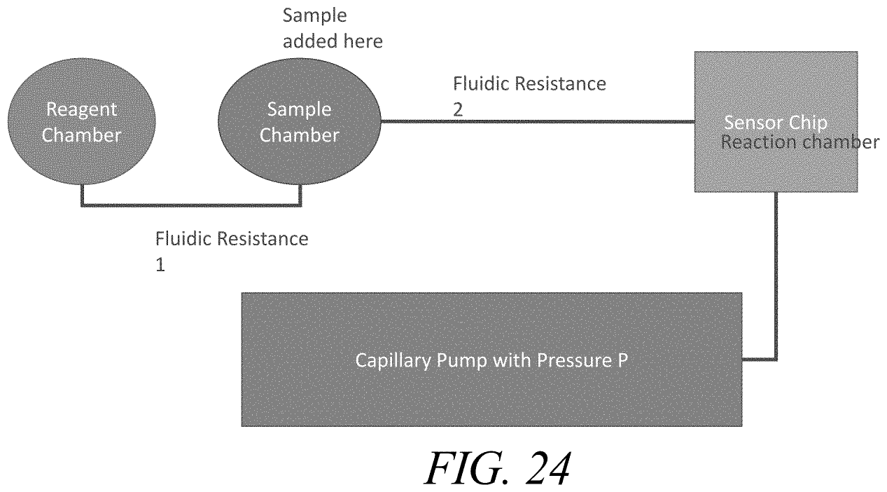

Referring to FIGS. 24-27, exemplary passive flow microfluidic devices (i.e., microfluidic cartridges) are illustrated by way of block diagrams. In some cases, exemplary microfluidic cartridge may be designed such that there are at least two connected chambers. In some embodiments, a liquid sample may be added to a sample chamber and flow into a reagent chamber or chambers, as well as into a sensor interface (i.e., reaction chamber) proximal sensor device (i.e., sensor chip) by passive flow mechanism, such as capillary and hydrostatic pressure. In some cases, reagent chamber or chambers maybe located in fluidic communication between a sample chamber and a sensor device and/or the sample chamber may be located in fluidic communication between the reagent chamber and the sensor device. A reagent chamber may contain dried down reagents, lyophilized reagents, and/or a pad with dried down reagents.

Referring to FIG. 24, a first exemplary microfluidic device layout is illustrated by way of a block diagram. In some embodiments, first exemplary microfluid device layout may enable a multistep passively driven microfluidic assay.

Referring to FIG. 25, a second exemplary microfluidic device layout is illustrated by way of a block diagram. In some embodiments, second exemplary microfluidic device layout may enable a multistep assay and contain a capillary pump and bubble trap before a reaction chamber.

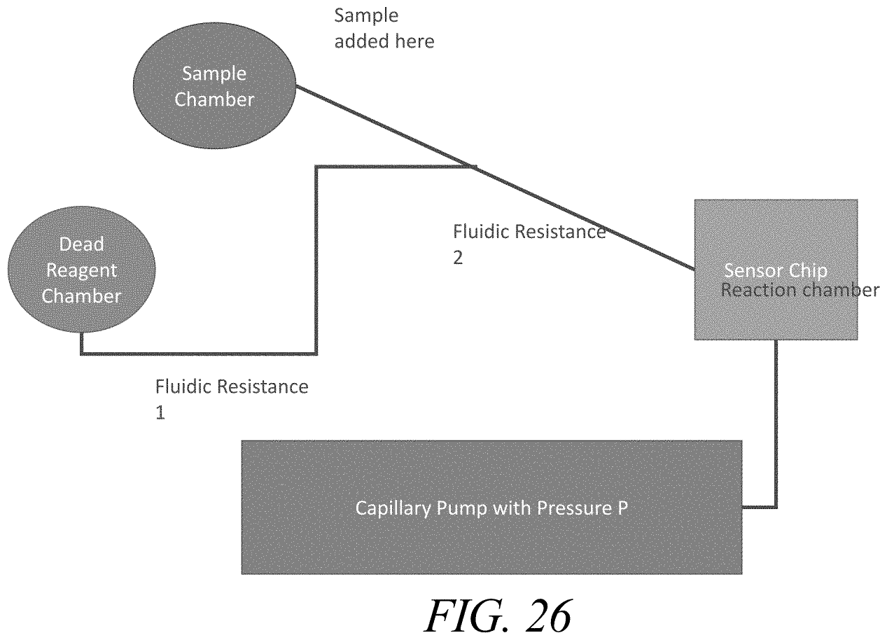

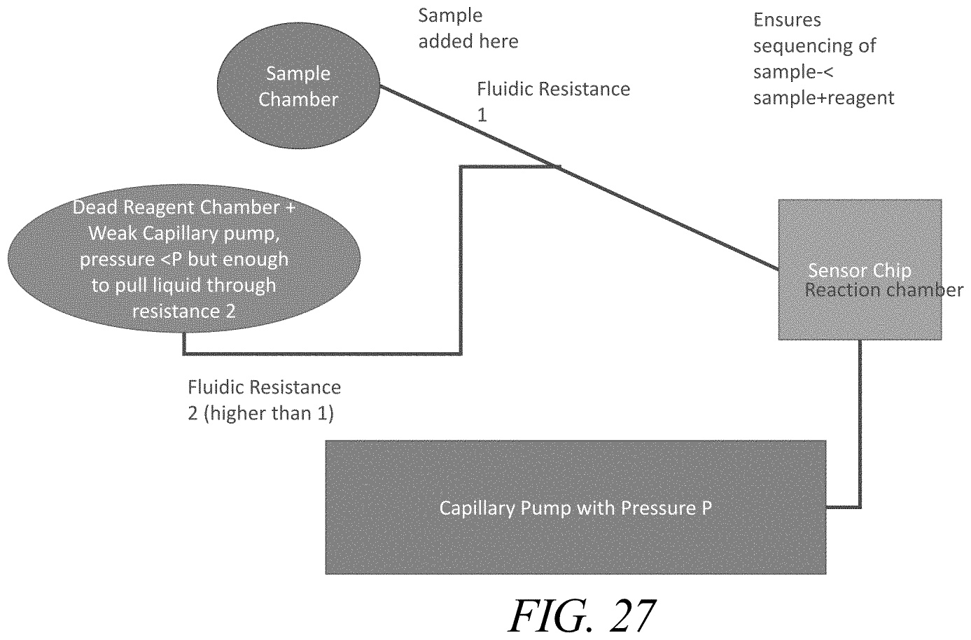

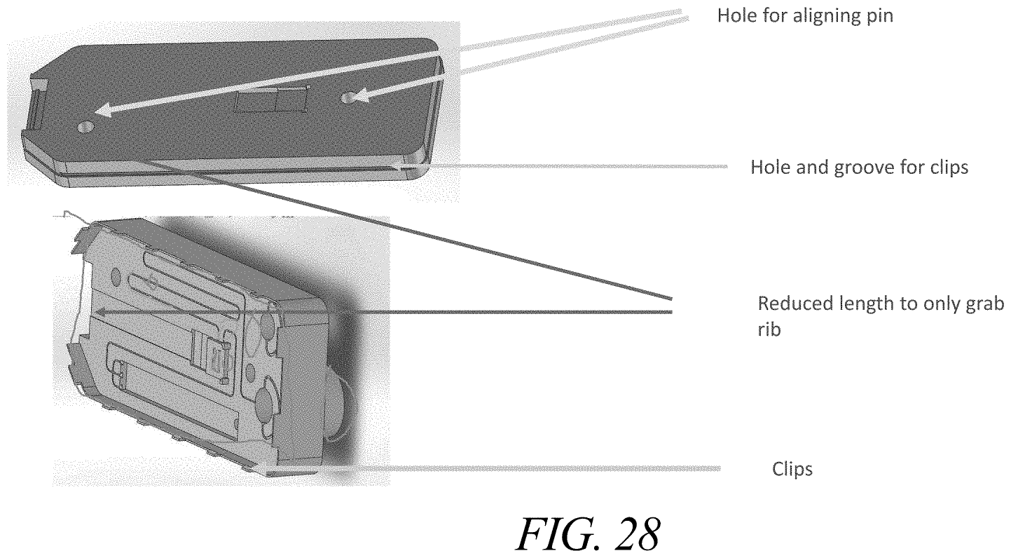

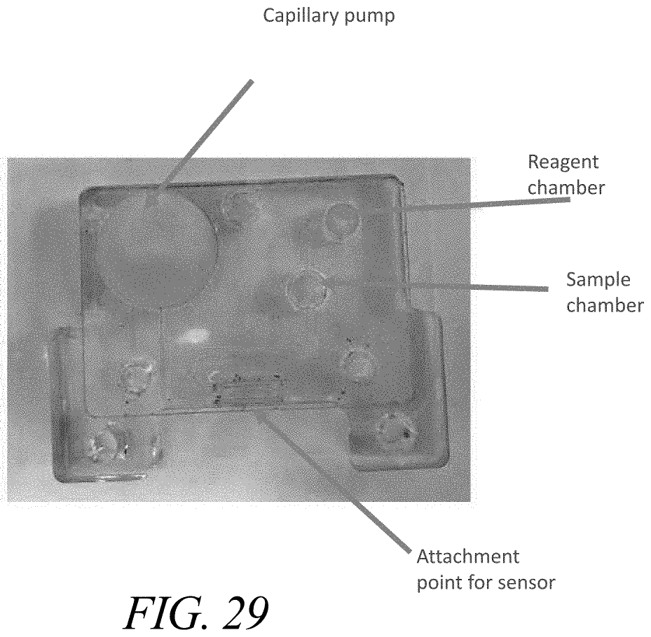

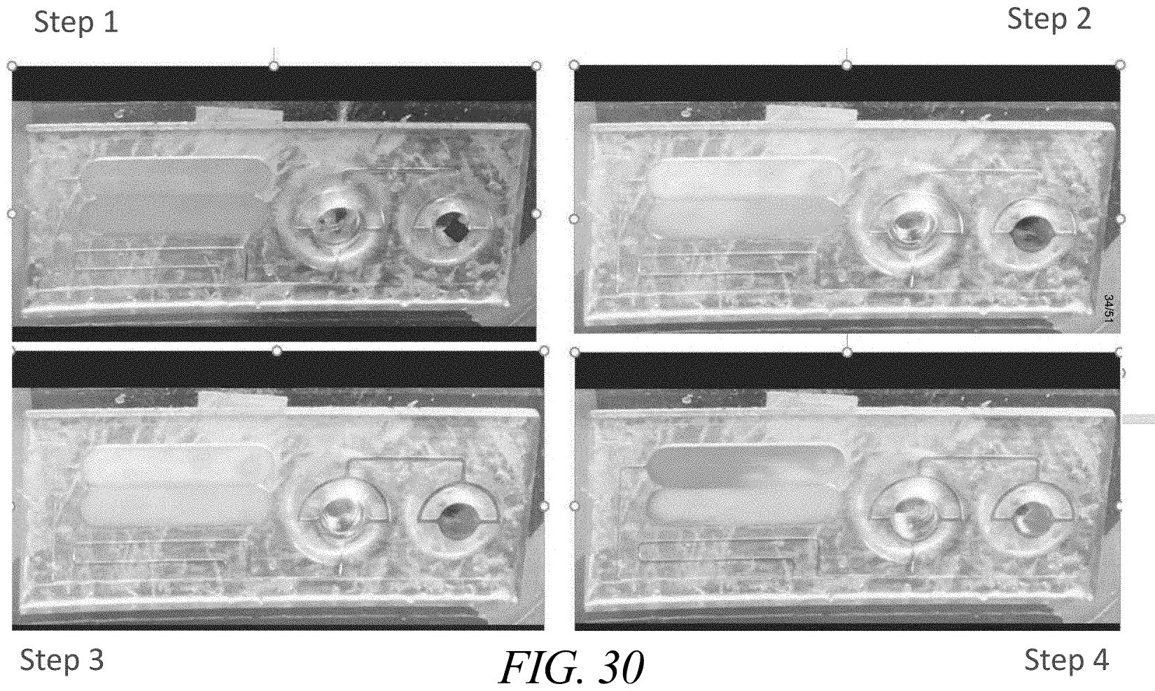

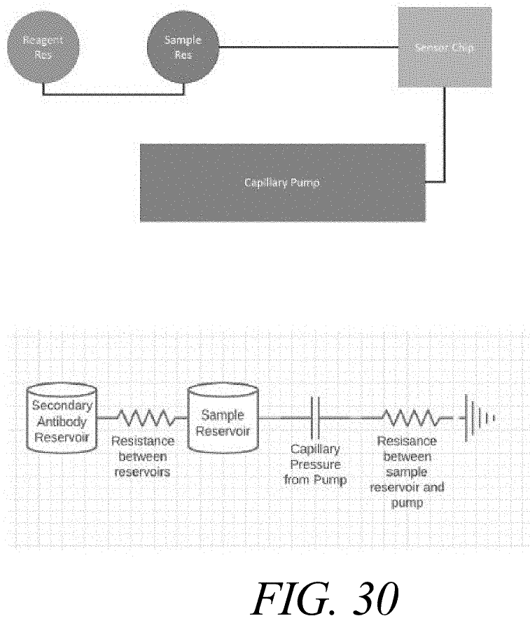

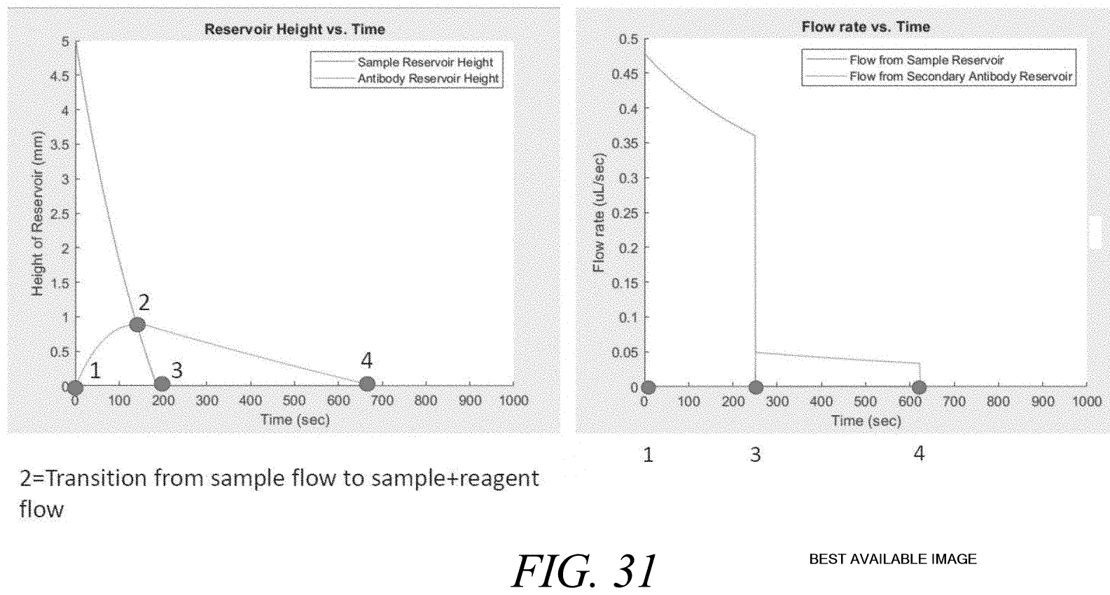

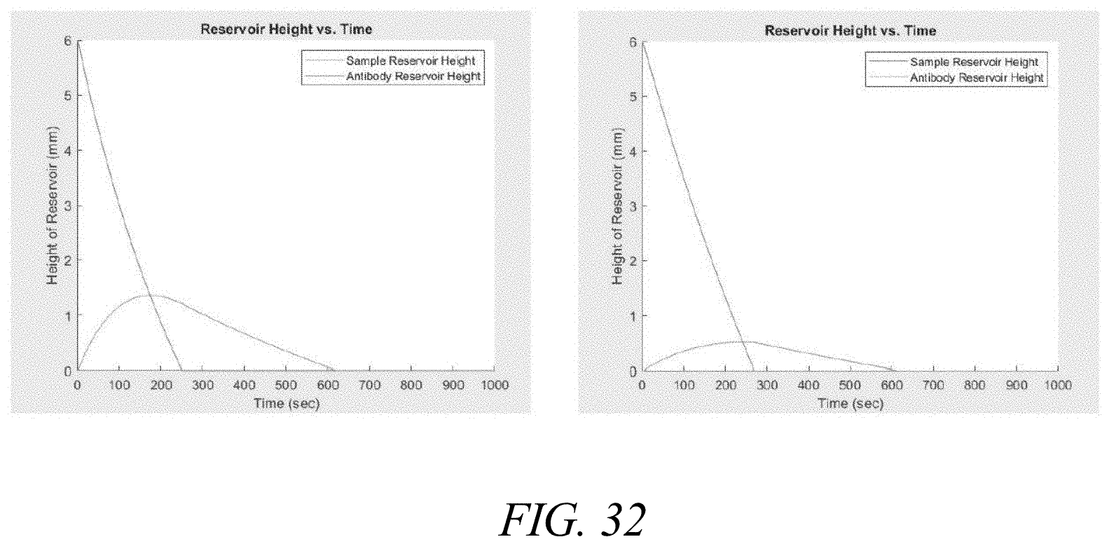

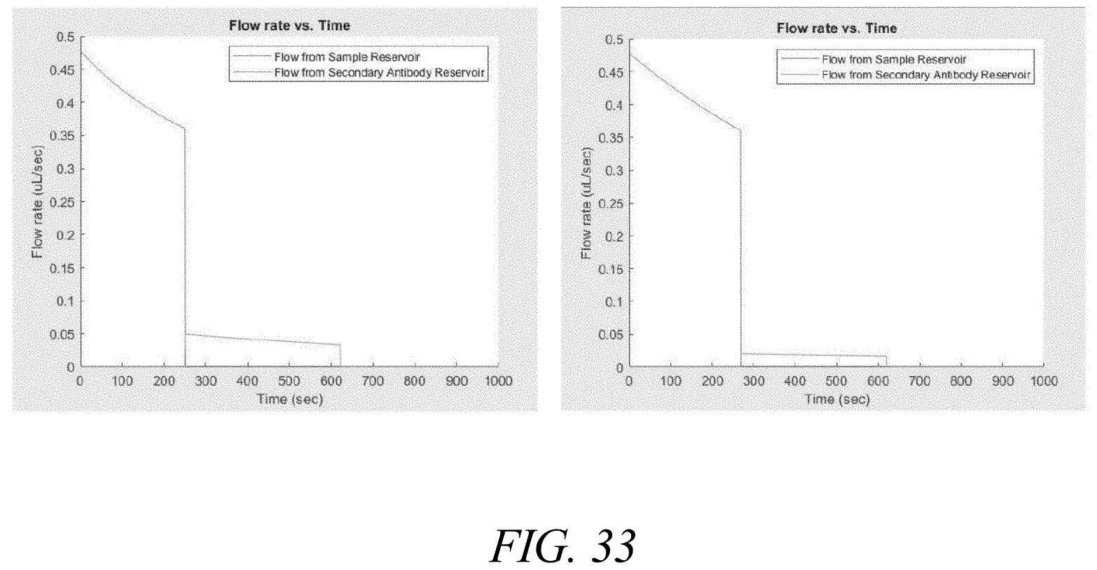

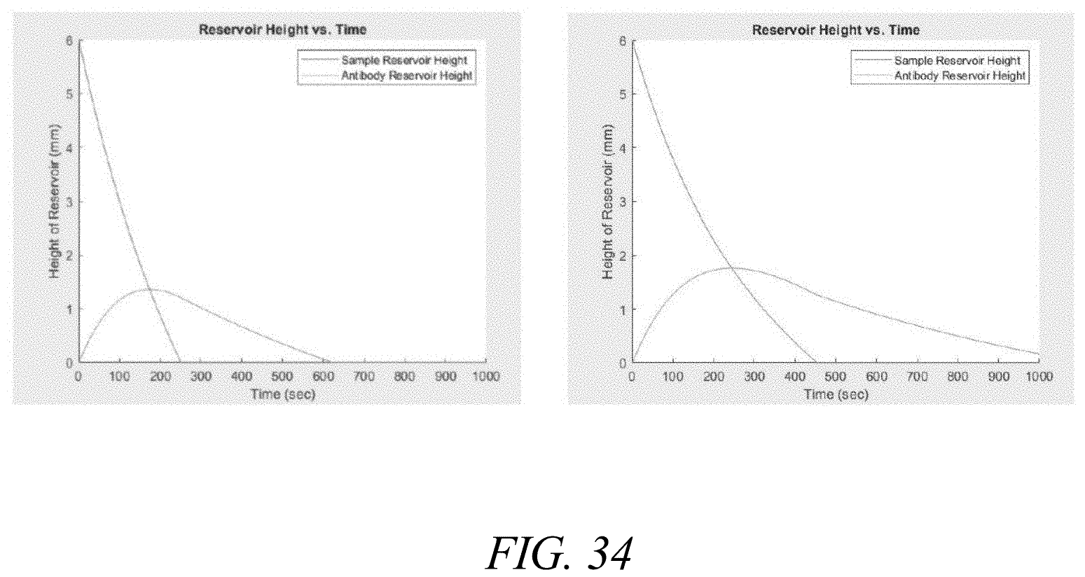

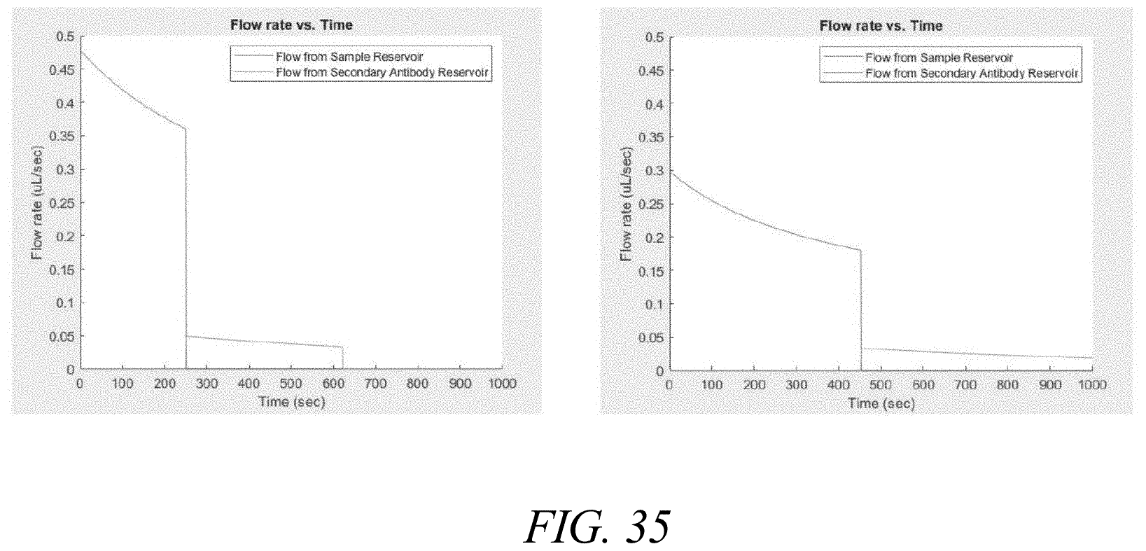

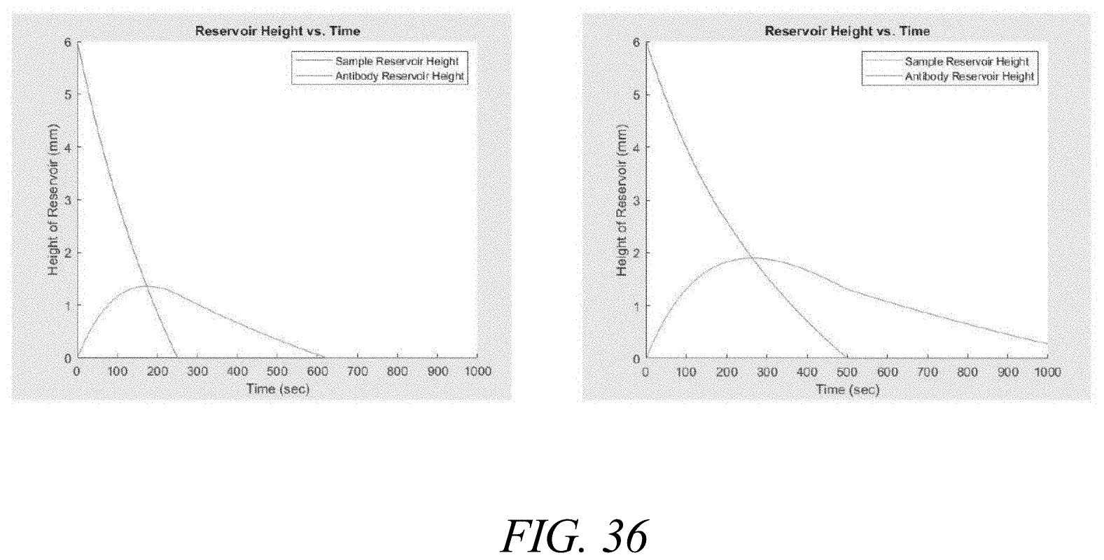

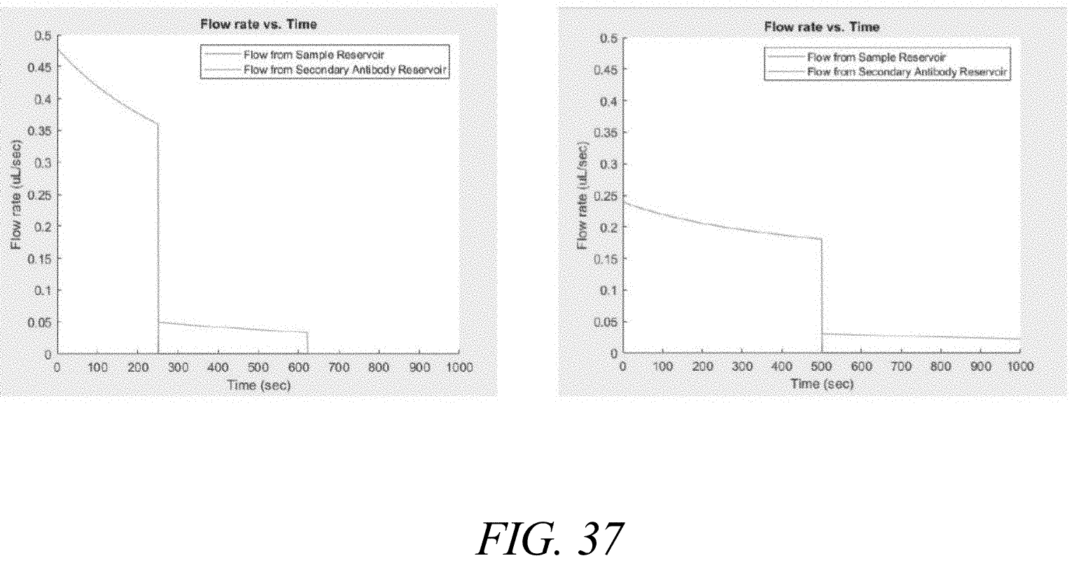

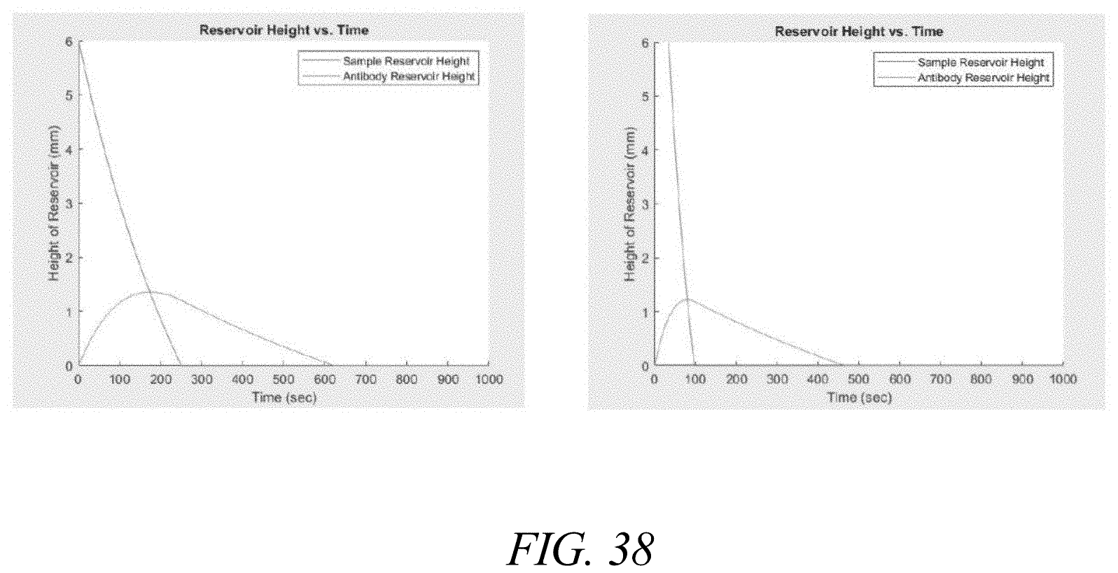

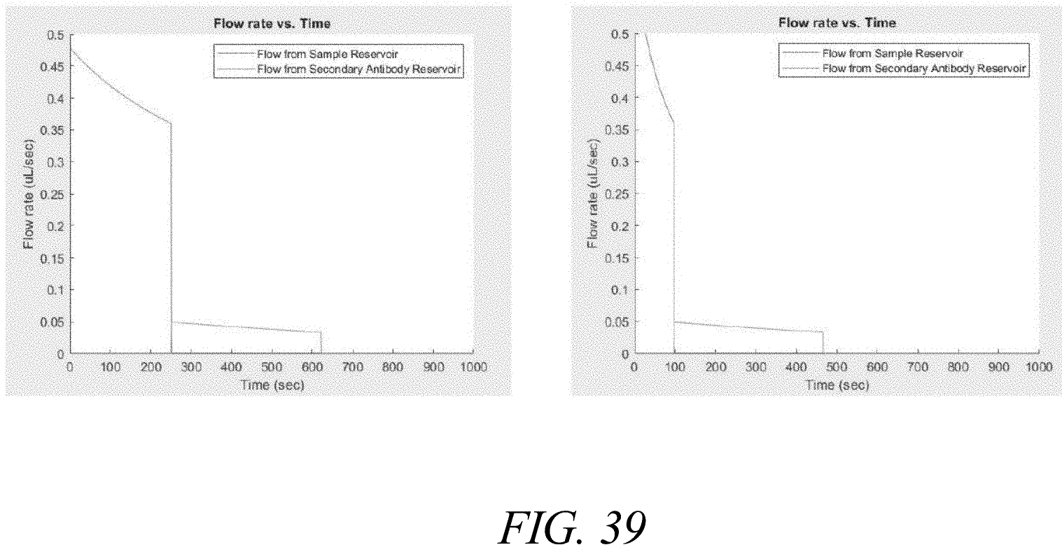

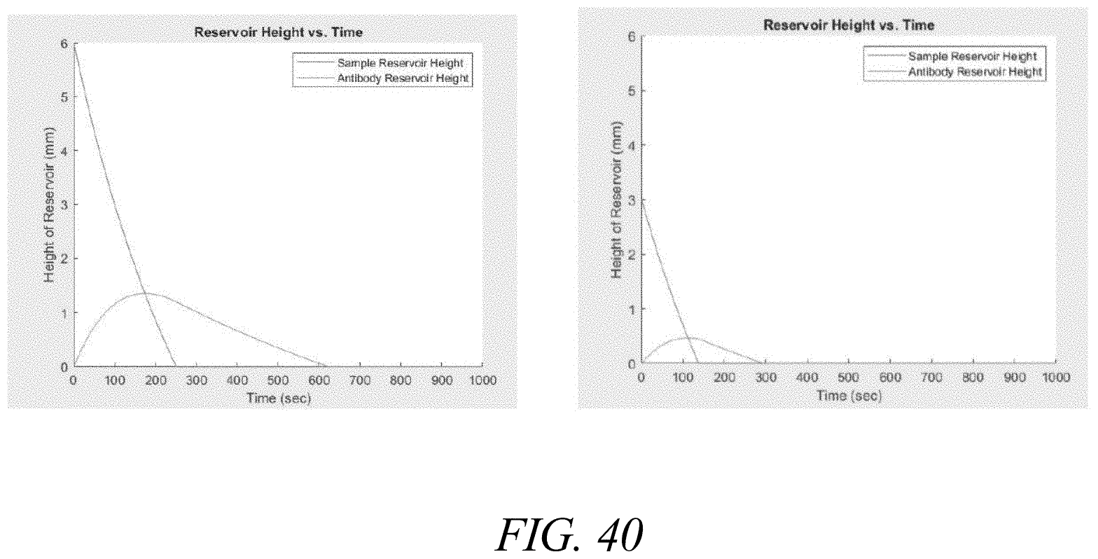

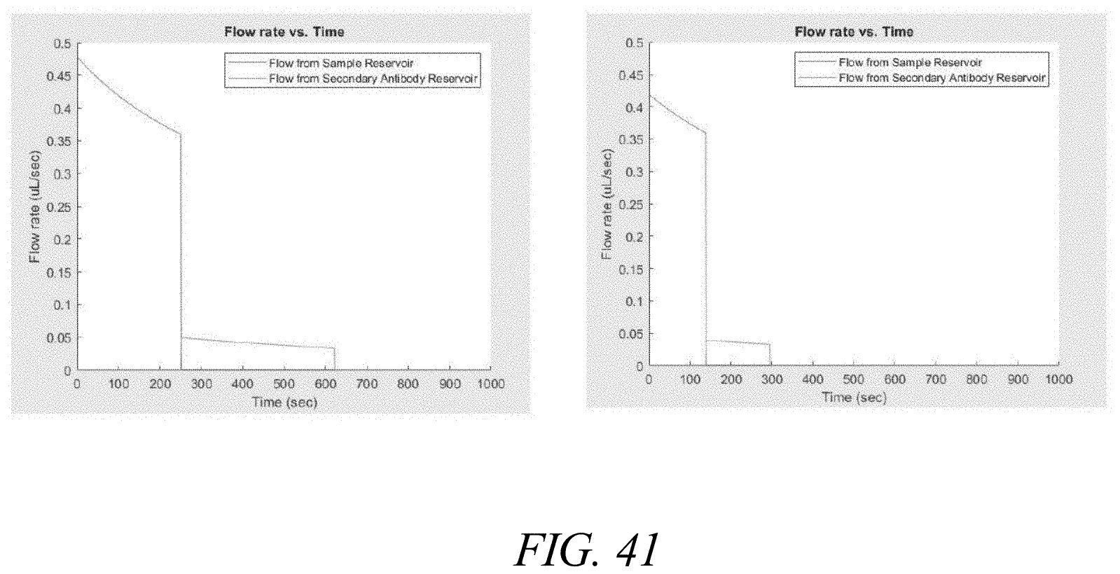

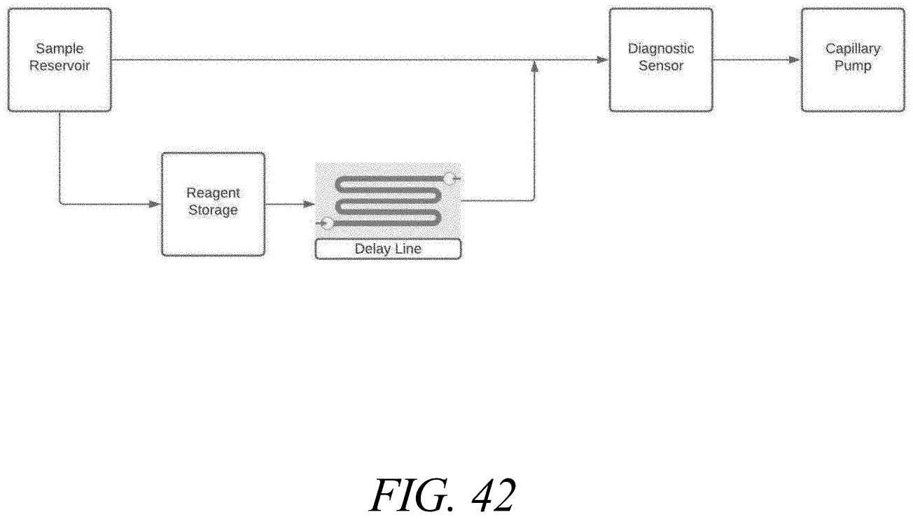

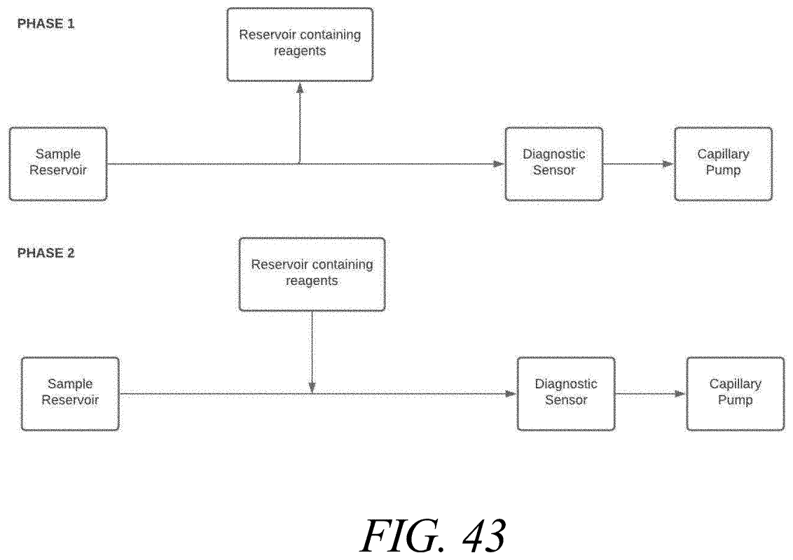

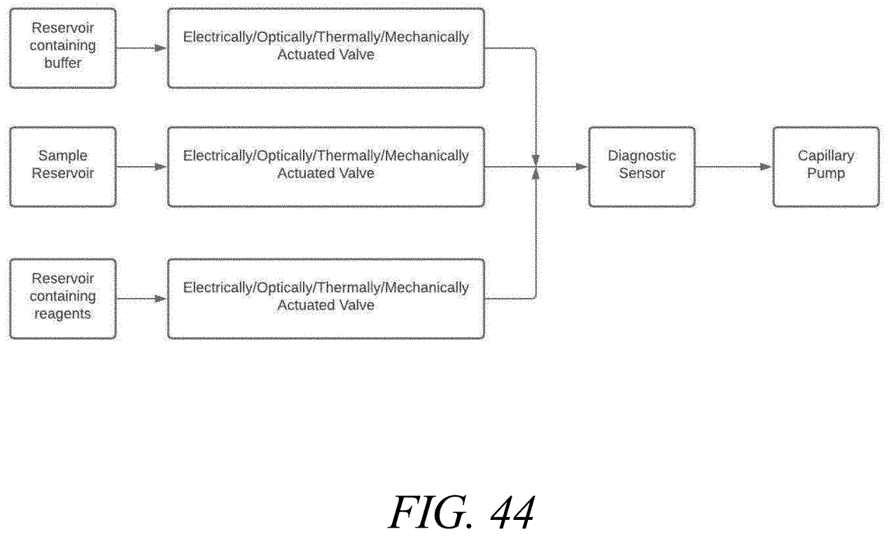

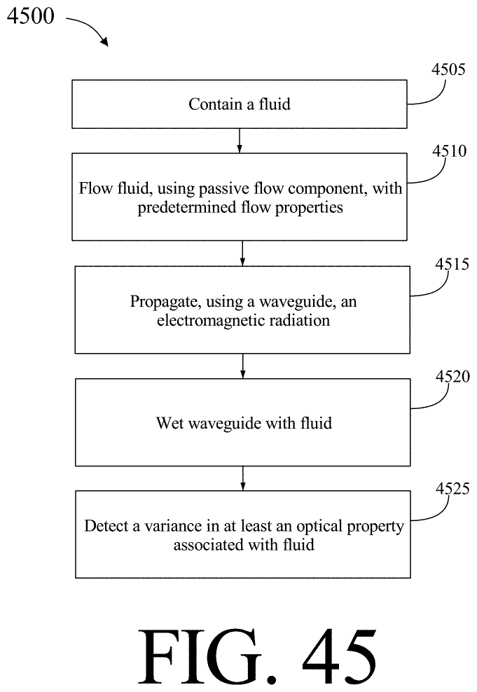

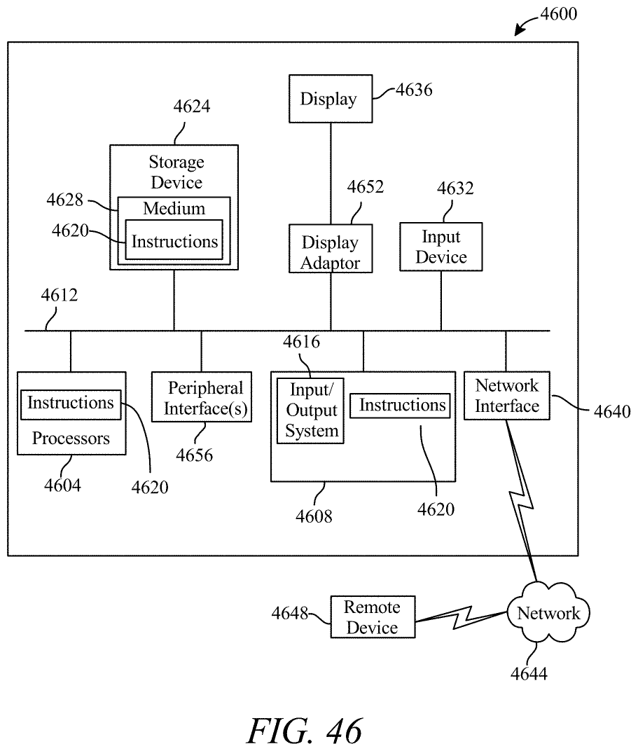

Referring to FIG. 26, a third exemplary microfluidic device layout is illustrated by way of a block diagram. In some embodiments, third exemplary microfluid device layout may have two steps sequenced via a delay line and merging channels.

Referring to FIG. 27, a fourth exemplary microfluidic device layout is illustrated by way of a block diagram. In some embodiments, fourth exemplary microfluidic device may have a dead-end reagent chamber allowing sequencing of assay steps.

### Exemplary Practical Embodiment

Referring to FIG. 28, an exemplary system for fluid sensing using passive flow is illustrated in two views. In some embodiments, locating features may be used to locate a sensor device 120 and a microfluidic device 108 relative one another, for example during assembly. Exemplary non-limiting locating features include holes for pin alignment, pins, grooves, shoulders, clips, tightly tolerance (less than +/−0.005″) surfaces, and the like. In some cases, locating features may be used to facilitate alignment. In some examples, a reduced length on one edge grabs a rib to facilitate alignment.

FIG. 29 shows an example of a device consisting of a capillary pump, reagent chamber, sample chamber, and an attachment point for sensor.

FIG. 30 illustrates a set of time lapse images (steps 1-4) of flow for an example passive-flow cartridge arrangement with a reagent chamber, sample chamber and capillary pump.

### Exemplary System Performance

Referring now to FIGS. 31-41, expected performance of a microfluidic system using passive flow (FIG. 30) are illustrated. Varying the resistances in channels in a Reagent Chamber-Sample Chamber-Sensor Reaction Chamber-Capillary Pump linear circuit allows for control over the timing of the flows. The results presented herein are modeling results which may be validated by experimentally measuring each parameter individually with a fluid of known viscosity (e.g. fill reservoirs with a known liquid volume and measure the time it takes to empty to a known volume and/or measure reagent concentration at the outlet as a function of time).

FIG. 30 outlines parameters of the model herein. These include sample reservoir dimensions (5 mm diameter, initial height 5-6 mm), dimensions of the reagent reservoir (4 mm diameter), capillary pressure created by the pump, resistance of channel between the sample reservoir and pump, resistance of channel between the two reservoirs, fluid viscosity, and fluid density. Diffusion was not included in the model.

Referring now to FIG. 31, stages of flow in the model are outlined, plotted as reservoir height (left) and flow rate (right) vs. time. The stage between point 1 and point 2 is where the buffer flows out to the capillary pump and to a secondary antibody reservoir. The stage between point 2 and point 3 is where liquid in the reagent reservoir begins to flow back into the sample chamber or “overlap time”. The stage between point 3 and point 4 is where the main sample reservoir empties and the liquid flows directly from the reagent reservoir, through the sample reservoir, and out to the capillary pump. Stage 4 is where the reagent reservoir empties the liquid.

FIGS. 32-33 show the model predicted effects of increasing resistance between reservoirs plotted as reservoir height vs. time (FIG. 32) and flow rate vs. time (FIG. 33). The transition from sample to sample+reagent flow (step 2) occurs at a later time. Additionally, the secondary antibody reservoir does not fill as high and flow rate of secondary antibody flow is reduced.

FIG. 34-35 show the model predicted effects of decreasing main capillary pump pressure plotted as reservoir height vs. time (FIG. 34) and flow rate vs. time (FIG. 35) in the model. The transition from sample to sample+reagent flow (step 2) occurs at a later time. Additionally, flow rate is significantly decreased, length of time for flow is significantly increased, and overlap time (2-3) is longer.

FIG. 36-37 show the model predicted effects of increasing main channel resistance plotted as reservoir height vs. time (FIG. 36) and flow rate vs. time (FIG. 37) in the model. Transition from sample to sample+reagent flow (step 2) occurs at a later time. Further, flow rate significantly decreased, length of time of flow increased, and overlap time increased.

FIG. 38-39 show the model predicted effects of reducing the diameter of main reservoir whilst increasing height to keep volume constant plotted as reservoir height vs. time (FIG. 38) and flow rate vs. time (FIG. 39) in the model. The transition from sample to sample+reagent flow (step 2) occurs at earlier time, the reagent reservoir does not fill as high and therefore empties earlier, and the length of overlap time (2-3) decreases.

FIG. 40-41 show the model predicted effects of reducing the initial sample volume plotted as reservoir height vs. time (FIG. 40) and flow rate vs. time (FIG. 41) in the model. The transition from sample to sample+reagent flow (step 2) occurs at earlier time, the secondary antibody reservoir does not fill as high and therefore empties earlier, and the overlap time decreases.

### Additional Embodiments

Still referring to FIG. 30, in some embodiments, a sticker may be removed from a cartridge to expose sample chamber and a hole that allows air to escape from a capillary pump when it fills with liquid. When sample is added to sample chamber it may begin to flow to reagent chamber via hydrostatic and capillary forces. Once within a reagent chamber, sample may rehydrate reagent. Sample may also flow toward sensor interface (i.e., reaction chamber) via hydrostatic and capillary forces and eventually reach capillary pump, which may pump liquid from the sample chamber. In some cases, once sample chamber and reagent chamber equilibrate in hydrostatic pressure (i.e., heights or pressure head of the liquids are the same) the liquid from sample chamber only flows towards a sensor reaction chamber (i.e., sensor chip), pulled by capillary pump. In some cases, liquid in reagent chamber begins to flow towards sample chamber as the sample chamber loses liquid and has lower hydrostatic pressure. If there is enough delay (either length or resistance or volume or a combination) in delay line between reagent chamber and sample chamber, the reagent may arrive to the sample chamber only after it is almost entirely empty, thus preventing mixing. From there liquid may be pulled by capillary pump to sensor interface. In some cases, this may accomplish a two-step assay: sample followed by sample with dissolved reagent (such as detection antibodies bound to colloidal gold or magnetic beads). In some embodiments, passive flow to a passive flow device (e.g., capillary pump) may be controlled (e.g., slowed) by affecting a vent of pump. For example, an air permeable membrane may be placed in a vent hole of a passive flow device, to create resistance. Alternatively or additionally, vent hole may be made smaller. In some embodiments, overfilling of a reservoir may be prevented. In some cases, overfilling may cause a change of timing and may be desirable to avoid. Overfill may be prevented by using an overflow chamber that may fill from a top of a sample chamber (i.e., reservoir), just as drain at a top of bathtub prevents overflow. Additionally, in some embodiments, reagent chamber(s) may have water impermeable, air permeable membranes on their vents preventing overfilling past their vents. In some cases, chambers may have an additional fluidic path fabricated about a perimeter, improving wetting and fluid flow (e.g., three walls to wet).

Referring now to FIG. 42, an exemplary microfluidic assay with two or more steps is illustrated by way of a block diagram. In some embodiments, an exemplary microfluidic assay with two or more steps may be sequenced via a delay line and merging channels. In a first step of an assay liquid may flow directly from a sample reservoir to a diagnostic sensor (i.e., sensor device and sensor interface). In a second step liquid which has flowed from sample reservoir through a chamber containing reagents flows to the diagnostic sensor. In some cases, a delay line can be created by various means of selecting properties (e.g., channel properties, flow properties, membrane properties, and the like), such as without limitation long flow paths, high flow resistances, dissolvable flow obstructions, and the like.

Continuing with FIG. 42, in some embodiments, a junction of two flow paths may not be permeable to air, and therefore liquid in a reagent flow path cannot flow into the diagnostic sensor until liquid downstream of the junction has been cleared, allowing air to escape. In another embodiment, junction of two flow paths may be permeable to air, allowing bubbles to escape as the two flow paths are merged.

In another embodiment shown in FIG. 43, a microfluidic assay with two or more steps includes a dead-end reagent chamber that allows sequencing of assay steps. In a first step of this assay, liquid flows from a sample reservoir to a diagnostic sensor (i.e., sensor interface and sensor device) and to a reservoir containing reagents, which may be dry. In a second step, reagents begin to flow from the reservoir containing reagents into the flowstream to the diagnostic sensor. This may occur via a flow reversal or via diffusion. In order to control the time between steps one and two, system properties may be selected including, without limitation variable flow resistances, path lengths, dissolvable materials, and the like. In some examples, it may be desirable to control a contact angle of microfluidic device (i.e., cartridge) within a certain range, (e.g., 20°-75°) for controllable capillary flow. For example, in some cases, if a contact angle is too low, fluid may run along sides of a channel, chamber, or passive flow device and trap air in a middle of a capillary. Alternatively, in some cases, if a contact angle is too high there may be little to no fluid flow.

Referring now to FIG. 44, a multi-step diagnostic assay can be achieved with valves that allow fluid to flow through them when their state is changed. These valves can be controlled by external means, such as electrical current, optical power, acoustic power, heat or direct mechanical actuation (e.g. plunger). In some embodiments each valve may correspond to a different flow path. The junction of these flow paths may include a means of allowing air to escape so as to prevent or reduce the formation of bubbles.

### Various Exemplary Summary Embodiments

Various non-limiting implementations of various components of the present disclosure are discussed below to provide more detail and clarity.

An exemplary microfluidic assembling device may comprise any and/or all of the following:

a. A channel plate that contains at least two segments of open channels on a planar surface;
b. A flow cell that contains an array of posts inside the flow chamber, the posts may be adjacent to each other to form a capillary post array;
c. A flow cell with an array of posts that connects to a channel at each end to form a fluidic flow path;
d. A layer of tape with an adhesive coating on one side that may be cut with two sizes of windows. A larger size of window may be cut only on the backing layer (e.g. not cut through the adhesive layer) and a smaller window may be cut through both the adhesive layer and backing layer of the tape;
e. A porous membrane strip that may be cut to fit with the larger window opening on the backing layer of the tape;
f. A sensor chip that may be placed in closed contact with porous membrane strip;
g. A sensor chip, porous membrane strip, adhesive tape, and channel plate may be compressed together by external fixture to form an assembled microfluidic device.

An exemplary channel plate may comprise any and/or all of the following:

a. At least two opened segments where one segment may be connected to an upstream fluidic path; the other segment connected to downstream fluidic path;
b. Fluidic flow from one segment of the channel, passing through capillary posts, then discharged into another segment of the channel;
c. A flow cell that may consist of an array of posts to form a capillary array;
d. Tips of posts that may not exceed the depth of the flow cell, their height may be smaller than the depth of the flow cell. In some cases, tips of posts may be flush to the surface of the channel plate;
e. An array of posts formed in a regular pitch pattern, wherein space between posts may allow a fluidic wicking effect to occur so that fluid can be pulled/pumped into the array to keep as a fluid source to the membrane strip.

An exemplary porous membrane strip that may comprise any and/or all of the following:

a. An aqueous absorption pad, which may draw fluid into its body and retains fluid to be saturated;
b. An absorption pad that may release fluid after it is saturated with fluid;
c. An absorption pad that may allow fluid to flow through its body at a certain flowrate;
d. An absorption pad that may absorb fluid from the flow cell at a rate such that there is no actual fluidic flow through the post array, rather, the array of posts draw fluid from an inlet channel which then supplies it to the pad;
e. An absorption pad cut to fit on the opening on the adhesive tape;
f. An absorption pad that may be adhered to the adhesive layer to hold it in place during assembling;
g. An absorption pad with a given pore size and material composition to allow fluid to flow through at a certain flow rate (e.g. 0.1-2.0 cm/second);
h. A pad that may let fluid pass through fast enough to keep the downstream channel wet and prevent it from drying out;
i. A pad that does not react to the sensor surface and any contents carried by the fluid in the microfluidic system;
j. Faster flow through the post array, such that the porous membrane strip serves as a wetting pad to supply reagents to the sensing surface.

An exemplary tape that may be placed at the surface of the channel plate that may comprise any and/or all of the following:

a. An adhesive layer on one side that may be hydrophilic;
b. An adhesive layer that may consist of a carrier layer with a double-sided adhesive coating;
c. A backing layer that may be cut and peeled off, leaving the adhesive layer in place;
d. An adhesive layer that maybe cut through leaving an open window;
e. A larger window that may be cut through a backing layer and that may be peeled off, leaving a portion of adhesive layer exposed;
f. An adhesive layer that adheres to the porous membrane strip and that may hold it in place during assembling;
g. An exposed area that may be around the cut-off opening or only on both ends of opening along the flow path, thus exposing sufficient area of adhesive to adhere to porous membrane strip;
h. An adhesive material that does not release chemicals causing interference to sensing or triggering secondary chemical reactions.

An exemplary surface of the sensor chip placed against surface of porous membrane strip, which may comprise any and/or all of the following:

a. An outer surface of the porous membrane strip that is higher than the surface of backing layer;
b. A porous membrane strip that may be compressed under moderate pressure, the surface of the strip being flush to the surface of the tape or cover plate;
c. A sensing area in contact with surface of porous membrane strip, where reagents carried by the fluid reach the surface of sensor;
d. A sensor surface that may be kept wet or moist constantly by the porous membrane strip;
e. The surface of the sensor chip that may be flat such that there is close contact with the surface of porous membrane strip to seal the area surrounding the strip or leave a slight gap;
f. The surface of the sensor chip that may be adhered to the adhesive layer of the tape which is exposed (e.g. like in the form of a picture frame) after the chip is mounted, thus sealing the porous membrane strip.

An exemplary cover plate that may be in addition or an alternative to the adhesive tape, which may comprise any and/or all of the following:

a. A cover plate that may seal the channel;
b. An area where an adhesive coating may be applied;
c. A layer forming a recessed area that may allow the porous membrane strip to fit securely;
d. A stage or step for applying an adhesive coating;
e. An open window to expose the flow cell area;

Exemplary placement of the porous membrane strip may be achieved by and/or all of the following:

a. An exposed adhesive coating surrounding opening widow on a tape or a cover plate;
b. A recessed cavity with a given size and height to allow the strip to fit securely;
c. A pressure-based mounting fixture which may compress the chip, tape, strip and channel plate together.

An exemplary housing fixture used to hold and press microfluidic chip, tape or cover plate, porous membrane strip and sensor chip together, which may comprise any/or all of the following:

a. A clamping fixture which applies moderate pressure from the sensor chip side towards the channel plate.
b. A channel plate that may be pre-assembled with cover tape or the cover plate;
c. An adhesive coating that may be applied onto the tape or cover plate at or near a cut-through window.

Exemplary construction of a flow cell that may comprise any and/or all of the following:

a. An array of posts built at the bottom of a cavity, wherein the height is flush to the surface of the channel block or flush to the surface of the cover plate;
b. The flow cell is connected to two segments of channels in two different directions;
c. A cavity without a post structure, thus allowing the porous membrane strip to set inside and on top of the surface of the strip that is flush to the surface of the channel plate or the surface of the cover plate.

Referring now to FIG. 45, a method 4500 for fluid sensing using passive flow is illustrated by way of a flow diagram. At step 4505, method 4500 may include containing, using at least a reservoir of a microfluidic device, at least a fluid. Reservoir may include any reservoir described in this disclosure, for example with reference to FIGS. 1-44 above. Microfluidic device may include any microfluidic device described in this disclosure, for example with reference to FIGS. 1-44 above. Fluid may include any fluid described in this disclosure, for example with reference to FIGS. 1-44 above.

With continued reference to FIG. 45, at step 4510, method 4500 may include flowing, using at least a passive flow component in fluidic communication with at least a reservoir, at least a fluid with predetermined flow properties. Passive flow component may include any passive flow component described in this disclosure, for example with reference to FIGS. 1-44 above. Predetermined flow properties may include any flow properties described in this disclosure, for example with reference to FIGS. 1-44 above.

With continued reference to FIG. 45, at step 4515, method 4500 may include propagating, using at least a waveguide of at least an optical device configured to be in sensed communication with at least a fluid, an electromagnetic radiation (EMR). Waveguide may include any waveguide described in this disclosure, for example with reference to FIGS. 1-44 above. Optical device may include any optical device described in this disclosure, for example with reference to FIGS. 1-44 above. Electromagnetic radiation may include any electromagnetic radiation described in this disclosure, for example with reference to FIGS. 1-44 above.

With continued reference to FIG. 45, at step 45020, method 4500 may include wetting, using at least an optical interface, at least a waveguide with at least a fluid. Optical interface may include any optical interface described in this disclosure, for example with reference to FIGS. 1-44 above.

With continued reference to FIG. 45, at step 4525, method 4500 may include detecting, using at least a sensor in optical communication with at least a waveguide, a variance in at least an optical property associated with at least a fluid. Sensor may include any sensor described in this disclosure, for example with reference to FIGS. 1-44 above. Variance may include any variance described in this disclosure, for example with reference to FIGS. 1-44 above. Optical property may include any optical property described in this disclosure, for example with reference to FIGS. 1-44 above.

Still referring to FIG. 45, in some embodiments of method 4500, at least an optical interface may include a flow cell. Flow cell may include any flow cell described in this disclosure, for example with reference to FIGS. 1-44 above. In some cases, flow cell may include a plurality of micro-posts. Micro-posts may include any micro-posts described in this disclosure, for example with reference to FIGS. 1-44 above.

Still referring to FIG. 45, in some embodiments of method 4500, at least an optical interface may include a porous membrane. Porous membrane may include any porous membrane described in this disclosure, for example with reference to FIGS. 1-44 above. In some cases, porous membrane may have at least a membrane property selected to achieve at least a flow property. Membrane property may include any membrane property described in this disclosure, for example with reference to FIGS. 1-44 above. Flow property may include any flow property described in this disclosure, for example with reference to FIGS. 1-44 above.

Still referring to FIG. 45, in some embodiments of method 4500, microfluidic device may include a plurality of channels. Channels may include any channels described in this disclosure, for example with reference to FIGS. 1-44 above.

Still referring to FIG. 45, in some embodiments of method 4500, at least a passive flow device may include a capillary pump. Capillary pump may include any capillary pump described in this disclosure, for example with reference to FIGS. 1-44 above.

Still referring to FIG. 45, in some embodiments of method 4500, predetermined flow properties may be selected to achieve a predetermined flow timing. Predetermined flow timing may include any predetermined flow timing described in this disclosure, for example with reference to FIGS. 1-44 above.

Still referring to FIG. 45, in some embodiments of method 4500, predetermined flow timing may be configured to cause a first fluid to wet at least a waveguide at a first time and a second fluid to wet the at least a waveguide at a second time. In some cases, second time may occur a predetermined time after a first time. In some cases, first fluid may include a sample, and second fluid may include a reagent.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random-access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

FIG. 4646 shows a diagrammatic representation of one embodiment of a computing device in the exemplary form of a computer system 4600 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 4600 includes a processor 4604 and a memory 4608 that communicate with each other, and with other components, via a bus 4612. Bus 4612 may include any of several types of bus structures including, but not limited to, a memory bus, a memory controller, a peripheral bus, a local bus, and any combinations thereof, using any of a variety of bus architectures.

Processor 4604 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 4604 may be organized according to Von Neumann and/or Harvard architecture as a non-limiting example. Processor 4604 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating-point unit (FPU), and/or system on a chip (SoC).

Memory 4608 may include various components (e.g., machine-readable media) including, but not limited to, a random-access memory component, a read only component, and any combinations thereof. In one example, a basic input/output system 4616 (BIOS), including basic routines that help to transfer information between elements within computer system 4600, such as during start-up, may be stored in memory 4608. Memory 4608 may also include (e.g., stored on one or more machine-readable media) instructions (e.g., software) 4620 embodying any one or more of the aspects and/or methodologies of the present disclosure. In another example, memory 4608 may further include any number of program modules including, but not limited to, an operating system, one or more application programs, other program modules, program data, and any combinations thereof.

Computer system 4600 may also include a storage device 4624. Examples of a storage device (e.g., storage device 4624) include, but are not limited to, a hard disk drive, a magnetic disk drive, an optical disc drive in combination with an optical medium, a solid-state memory device, and any combinations thereof. Storage device 4624 may be connected to bus 4612 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 4624 (or one or more components thereof) may be removably interfaced with computer system 4600 (e.g., via an external port connector (not shown)). Particularly, storage device 4624 and an associated machine-readable medium 4628 may provide nonvolatile and/or volatile storage of machine-readable instructions, data structures, program modules, and/or other data for computer system 4600. In one example, software 4620 may reside, completely or partially, within machine-readable medium 4628. In another example, software 4620 may reside, completely or partially, within processor 4604.

Computer system 4600 may also include an input device 4632. In one example, a user of computer system 4600 may enter commands and/or other information into computer system 4600 via input device 4632. Examples of an input device 4632 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 4632 may be interfaced to bus 4612 via any of a variety of interfaces (not shown) including, but not limited to, a serial interface, a parallel interface, a game port, a USB interface, a FIREWIRE interface, a direct interface to bus 4612, and any combinations thereof. Input device 4632 may include a touch screen interface that may be a part of or separate from display 4636, discussed further below. Input device 4632 may be utilized as a user selection device for selecting one or more graphical representations in a graphical interface as described above.

A user may also input commands and/or other information to computer system 4600 via storage device 4624 (e.g., a removable disk drive, a flash drive, etc.) and/or network interface device 4640. A network interface device, such as network interface device 4640, may be utilized for connecting computer system 4600 to one or more of a variety of networks, such as network 4644, and one or more remote devices 4648 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 4644, may employ a wired and/or a wireless mode of communication. In general, any network topology may be used. Information (e.g., data, software 4620, etc.) may be communicated to and/or from computer system 4600 via network interface device 4640.

Computer system 4600 may further include a video display adapter 4652 for communicating a displayable image to a display device, such as display device 4636. Examples of a display device include, but are not limited to, a liquid crystal display (LCD), a cathode ray tube (CRT), a plasma display, a light emitting diode (LED) display, and any combinations thereof. Display adapter 4652 and display device 4636 may be utilized in combination with processor 4604 to provide graphical representations of aspects of the present disclosure. In addition to a display device, computer system 4600 may include one or more other peripheral output devices including, but not limited to, an audio speaker, a printer, and any combinations thereof. Such peripheral output devices may be connected to bus 4612 via a peripheral interface 4656. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A system for fluid sensing using passive flow, the system comprising:
a microfluidic device, the microfluidic device comprising:
at least a reservoir configured to contain at least a fluid;
at least a passive flow component in fluidic communication with the at least a reservoir and configured to flow the at least a fluid with predetermined flow properties;
at least a sensor device configured to be in sensed communication with the at least a fluid and detect at least a sensed property; and
at least a sensor interface configured to wet at least a surface of the at least a sensor device with the at least a fluid.

2. The system of claim 1 wherein the at least a sensor device comprises:
at least a waveguide configured to propagate an electromagnetic radiation (EMR); and
at least an optical sensor in optical communication with the at least a waveguide configured to detect a variance in at least an optical property associated with the at least a sensed property; and
wherein the at least a sensor interface includes an optical interface configured to wet the at least a waveguide.

3. The system of claim 1, wherein the at least a sensor interface includes a flow cell.

4. The system of claim 1, wherein the flow cell includes a plurality of micro-posts.

5. The system of claim 1, wherein the at least a sensor interface includes a porous membrane.

6. The system of claim 1, wherein the porous membrane has at least a membrane property selected to achieve at least a flow property.

7. The system of claim 1, wherein the at least a passive flow device includes a capillary pump.

8. The system of claim 1, wherein the predetermined flow properties are selected to achieve a predetermined flow timing.

9. The system of claim 1, wherein the predetermined flow timing is configured to cause:
a first fluid to wet the at least a surface of the at least a sensor device at a first time; and
a second fluid to wet the at least a surface of the at least a sensor device at a second time, wherein the second time occurs a predetermined time after the first time.

10. The system of claim 9, wherein the first fluid comprises a sample and the second fluid comprises a reagent.

11. A method for fluid sensing using passive flow, the method comprising:
containing, using at least a reservoir of a microfluidic device, at least a fluid;
flowing, using at least a passive flow component in fluidic communication with the at least a reservoir, the at least a fluid with predetermined flow properties;
wetting, using at least a sensor interface, at least a surface of at least a sensor device with the at least a fluid; and
detect, using the at least a sensor device configured to be in sensed communication with the at least a fluid, as least a sensed property.

12. The method of claim 11, further comprising:
propagating, using at least a waveguide of the at least a sensor device configured to be in sensed communication with the at least a fluid, an electromagnetic radiation (EMR);
wetting, using the at least an optical interface of the at least a sensor interface, the at least a waveguide;
detecting, using at least an optical sensor in optical communication with the at least a waveguide, a variance in at least an optical property associated with the at least a sensed property.

13. The method of claim 11, wherein the at least a sensor interface includes a flow cell.

14. The method of claim 11, wherein the flow cell includes a plurality of micro-posts.

15. The method of claim 11, wherein the at least a sensor interface includes a porous membrane.

16. The method of claim 11, wherein the porous membrane has at least a membrane property selected to achieve at least a flow property.

17. The method of claim 11, wherein the at least a passive flow device includes a capillary pump.

18. The method of claim 1, wherein the predetermined flow properties are selected to achieve a predetermined flow timing.

19. The method of claim 11, wherein the predetermined flow timing is configured to cause:
a first fluid to wet the at least a waveguide at a first time; and
a second fluid to wet the at least a waveguide at a second time, wherein the second time occurs a predetermined time after the first time.

20. The method of claim 19, wherein the first fluid comprises a sample and the second fluid comprises a reagent.
